(19) United States
(12) Patent Application Publication
(10) Pub. No.: US 2008/0303002 A1
(43) Pub. Date: Dec. 11, 2008

(54) DISPLAY MATERIAL AND AUTOMOBILE MEMBER

(76) Inventor: Takashi KATO, Kanagawa (JP)

Correspondence Address: BIRCH STEWART KOLASCH & BIRCH, PO BOX 747, FALLS CHURCH, VA, 22040-0747, US

(21) Appl. No.: 12/132,414

(22) Filed: Jun. 3, 2008

(30) Foreign Application Priority Data
Jun. 7, 2007 (JP) 2007-151385

(51) Int. Cl. C09K 19/34; C09K 19/00

(52) U.S. Cl. 252/299.61; 252/299.6

(57) ABSTRACT

A display material or automobile member of the present invention includes at least one cholesteric liquid crystal layer, an optical property of which is changed by an electric field, and the cholesteric liquid crystal layer contains at least one chiral reagent having one or more fluorine atoms, and at least one nematic liquid crystal. The nematic liquid crystal preferably has an absolute value of dielectric constant anisotropy of 1.0 or more.

### CROSS REFERENCE TO RELATED APPLICATIONS

This application claims priority under 35USC 119 from Japanese Patent Application No. 2007-151385, the disclosure of which is incorporated herein by reference.

### BACKGROUND OF THE INVENTION

1. Field of the Invention

The present invention relates to a display material and an automobile member, more particularly the display material and the automobile member whose optical properties are changed by the electric field.

2. Description of the Related Art

A cholesteric liquid crystal phase may be used as a display material utilizing selective reflection, because a cholesteric liquid crystal phase has a property that when its spiral pitch is made to be around a wavelength of light, it selectively reflects light of a specified wavelength. A cholesteric liquid crystal phase may be also used as a display material utilizing so-called guest-host liquid crystal system, when a dichroic dye is added to the cholesteric liquid crystal phase. These display materials are used in display document information, display imaging information, or light modulating material which control light electrically.

Like this, the display material utilizing the cholesteric liquid crystal phase has preciously been studied much, but it has a problem that a driving voltage is high. When reduction in the driving voltage, it leads to reduction in a consumed power and, from a viewpoint of giving no load on the environment, it is important to develop a liquid crystal display material having a low driving voltage. In addition, when the driving voltage is reduced, it becomes possible to make a driver for driving inexpensive, and the reduction is important also from a viewpoint of the cost. In addition, when the driving voltage is reduced, it becomes possible to decrease deterioration of the display material, and this is advantageous in longer life.

Since reduction in the driving voltage has many merits as described above, reduction in the driving voltage has preciously been tried. It is possible to reduce the driving voltage by changing a structure of the liquid crystal compound, as the driving voltage is a necessary voltage for changing orientation of the liquid crystal compound. Specifically, for example, Japanese Patent Application Laid Open (JP-A) No. 2004-67996 reports that the liquid crystal compound having a fluorine-substituted structure reduces the driving voltage. Since the high or low driving voltage is directly linked with a structure of the liquid crystal compound, it was generally thought that, for reducing the driving voltage, only one way is to change a structure of the liquid crystal compound itself, as described above.

In addition, in the automobile member, arbitral control of optical property of the member is important from a viewpoint of the environment and energy saving. Although the technique capable of arbitrarily controlling optical property of the automobile member has preciously been studied, it has not been necessarily at a satisfactory level from a viewpoint of durability and optical property. That is, when a structural color member was used as a member for a vehicle such as an automobile, vibration and impact were added, color unevenness occurred and visibility was deteriorated in some cases. In addition, there was also a problem that, when a structural color is applied to a relatively large area such as the automobile, display performance varies depending on a place. Various display materials have preciously been studied, but there is little display material excellent in display performance for vibration and impact under the current circumstances.

### SUMMARY OF THE INVENTION

A first aspect of the present invention is a display material comprising at least one cholesteric liquid crystal layer whose optical property is changed by an electric field, wherein the cholesteric liquid crystal layer comprises at least one chiral reagent having one or more fluorine atoms, and at least one nematic liquid crystal.

A second aspect of the present invention is an automobile member comprising at least one cholesteric liquid crystal layer whose optical property is changed by an electric field, wherein the cholesteric liquid crystal layer comprises at least one chiral reagent having one or more fluorine atoms, and at least one nematic liquid crystal

### DETAILED DESCRIPTION OF THE INVENTION

The present inventors intensively studied to obtain the finding that, by using a particular material, that is, a cholecteric liquid crystal including at least one chiral reagent having at least one fluorine atom, and at least one nematic liquid crystal, a display material having a low driving voltage may be provided and, based on this finding, the present inventors further studied to result in completion of the present invention. In addition, the present inventors obtained the finding that an automobile member including this cholesteric liquid crystal is excellent in display performance with respect to vibration and impact, resulting in completion of the present invention.

The present invention will be described in detail below. In the present specification “ . . . to . . . ” represents a range including the numeral values represented before and after “to” as a minimum value and a maximum value, respectively.

### <Display Material>

In the display material of the present invention, the cholesteric liquid crystal layer is disposed between one pair of electrodes, at least one of which is a transparent electrode, via a spacer. By applying a voltage to this electrode, optical property of a liquid crystal is changed due to the electric field and display may be changed.

### [Cholesteric Liquid Crystal Layer]

The display material of the present invention has at least one cholesteric liquid crystal layer, optical property of which may be changed due to the electric field. The cholesteric liquid crystal layer means a layer exhibiting a cholesteric phase under at least 5° C. to 40° C. Preferably, the layer is a layer exhibiting a cholesteric phase at 0° C. to 60° C. The cholesteric liquid crystal may or may not have memory property. It becomes possible to electrically switch the transparent state and the reflection state.

The cholesteric liquid crystal layer according to the present invention contains at least a chiral reagent and a nematic liquid crystal. A composition of the cholesteric liquid crystal layer will be explained in detail below.

### (Chiral Reagent)

In the present invention, at least one chiral reagent having at least one fluorine atom is used. Generally, when an addition amount of the chiral reagent is adjusted so that a chiral pitch length becomes the same, a driving voltage of the resulting liquid crystal exhibits an approximately constant value not depending on the kinds of the chiral reagent added. From this, it has previously been thought that, for reducing the driving voltage of the liquid crystal, the only option is to change a structure of the liquid crystal compound.

However, in the present invention, an unexpected effect was made clear in that the driving voltage is reduced by applying the chiral reagent having a fluorine atom. The reason why this effect is exerted has not been elucidated, but it is presumed to be due to the fact that interaction between the liquid crystal and the chiral reagent is changed and an elastic constant of the cholesteric phase dominating the driving voltage is mainly changed. Therefore, it is thought that a similar effect is shown as long as the chiral reagent is a chiral reagent having a fluorine atom. It should be noted that the present invention is not limited by the above presumption.

In addition, the display material using at least one chiral reagent having at least one fluorine atom suppresses deterioration of display performance with respect to vibration and impact. When vibration or impact is imparted, a cell gap becomes non-uniform, or a periodic structure of the cholecteric liquid crystal becomes non-uniform, whereby visibility is deteriorated, such as by occurrence of display unevenness, in some cases. However, when the cholecteric liquid crystal including the chiral reagent according to the present invention is used, the cholecteric liquid crystal has capable of rapidly returning to the original state, thereby showing the unexpected effect, like suppressing reduction in the display performance.

On the other hand, in the case of a cholesteric liquid crystal using a chiral reagent with no fluorine atom introduced therein, the molecular arrangement of the cholecteric liquid crystal is hard to be returned to the original state after the molecular arrangement thereof is disordered by vibration or impact, thereby remaining display unevenness.

As the chiral reagent used in the present invention, from a viewpoint of that the driving voltage is further reduced, a chiral reagent represented by the following Formula (2) is preferable.

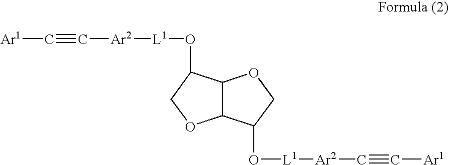

In Formula (2), Ar¹ and Ar² each independently represent an aromatic hydrocarbon group or an aromatic heterocyclic group, provided that at least one of Ar¹ and Ar² is an aromatic hydrocarbon group having a fluorine atom or an aromatic heterocyclic group having a fluorine atom. L¹ represents a single bond or divalent linking group. Two groups represented by Ar¹ may be the same or different, two groups represented by Ar² may be the same or different, two groups represented by L¹ may be the same or different. The aromatic hydrocarbon group, the aromatic heterocyclic group and the divalent linking group may have a substituent.

Formula (2) will be further explained in detail in below.

In Formula (2), Ar¹ and Ar² each independently represent an aromatic hydrocarbon group or an aromatic heterocyclic group, and at least one of Ar¹ and Ar² is an aromatic hydrocarbon group having a fluorine atom or an aromatic heterocyclic group having a fluorine atom. Examples of an aromatic hydrocarbon ring constituting these groups include benzene and naphthalene, and examples of an aromatic heterocyclic ring include pyridine, pyrazine, pyrimidine, pyridazine, thiophene, furan, pyrazole, imidazole, triazole, thiadiazole, and oxadiazole.

Ar¹ in Formula (2) is preferably an aromatic hydrocarbon ring group, and particularly preferably a group containing a benzene ring.

Ar¹ in Formula (2) is preferably an aromatic hydrocarbon ring group or an aromatic 6-membered heterocyclic group, more preferably an aromatic hydrocarbon ring group, and furthermore preferably a group containing a benzene ring.

A substitution position of a fluorine atom possessed by the aromatic hydrocarbon group or the aromatic heterocyclic group of Ar¹ and Ar² in Formula (2) may be any position and, from a viewpoint of that compatibility with the liquid crystal is enhanced, it is preferable that the aromatic hydrocarbon is directly substituted with a fluorine atom.

The number of fluorine atoms of each of the aromatic hydrocarbon group or the aromatic heterocyclic group represented by Ar¹ and Ar² is not particular limited as long as it is 1 or more, and the number of fluorine atoms is preferably from 1 to 3, and more preferably 1 or 2.

L¹ represents a single bond or a divalent linking group. Examples of the divalent lining group include —O—, —S—, —NH—, —C(═O)—, —CH₂—, —CH═CH—, —C≡C—, —SO₂—, and —SO—, and plural of them may be taken together to form a divalent linking group, however plural oxygen atoms are not directly bound.

The divalent linking group is preferably —C(═O)—, —CH₂— or —SO₂—, and more preferably —C(═O)— or —CH₂—.

Ar¹, Ar² and L¹ which are present at the plural number in Formula (2) may be the same or the different, respectively, and from a viewpoint that a twisting force of the chiral reagent is enhanced, they are preferably the same.

In Formula (2), the aromatic hydrocarbon group or the aromatic heterocyclic group represented by Ar¹ or Ar² may have a substituent other than a fluorine atom. The divalent linking group represented by L¹ in Formula (2) may have a substituent. Examples of such the substituent include a hydroxy group, a halogen atom (e.g. F, Cl, Br), a cyano group, a nitro group, a carboxyl group, a sulfo group, a liner or cyclic alkyl group having from 1 to 20 carbon atoms (e.g. methyl, ethyl, isopropyl, n-butyl, n-hexyl, cyclopropyl, cyclohexyl, 2-hydroxyethyl, 4-carboxybutyl, 2-methoxyethyl, 2-diethylaminoethyl), an alkenyl group having from 1 to 20 carbon atoms (e.g. vinyl, allyl, 2-hexenyl), an alkynyl group having from 2 to 20 carbon atoms (e.g. ethynyl, 1-butynyl, 3-hexynyl), an aralkyl group having from 7 to 20 carbon atoms (e.g. benzyl, phenethyl), an aryl group having from 6 to 20 carbon atoms (e.g. phenyl, naphthyl, 4-carboxyphenyl, 4-acetamidophenyl, 3-methanesulfonamidophenyl, 4-methoxyphenyl, 3-carboxyphenyl, 3,5-dicarboxyphenyl, 4-methanesulfonamidophenyl, 4-butanesulfonamidophenyl), an acyl group having from 1 to 20 carbon atoms (e.g. acetyl, benzoyl, propanoyl, butanoyl), an alkoxycarbonyl group having from 2 to 20 carbon atoms (e.g. methoxycarbonyl, ethoxycarbonyl), an aryloxycarbonyl group having from 7 to 20 carbon atoms (e.g. phenoxycarbonyl, naphthoxycarbonyl), a carbamoyl group having from 1 to 20 carbon atoms (e.g. non-substituted carbamoyl, methylcarbamoyl, diethylcarbamoyl, phenylcarbamoyl), an alkoxy group having from 1 to 20 carbon atoms (e.g. methoxy, ethoxy, butoxy, methoxyethoxy), an aryloxy group having from 6 to 12 carbon atoms (e.g. phenoxy, 4-carboxyphenoxy, 3-methylphenoxy, naphthoxy), an acyl group having from 2 to 20 carbon atoms (e.g. acetoxy, benzoyloxy), a sulfonyloxy group having from 1 to 20 carbon atoms (e.g. methylsulfonyloxy, phenylsulfonyloxy), an amino group having from 0 to 20 carbon atoms (e.g. non-substituted amino, dimethylamino, diethylamino, 2-carboxyethylamino), an acylamino group having from 1 to 20 carbon atoms (e.g. acetamido, benzamido), a sulfonylamino group having from 1 to 20 carbon atoms (e.g. methylsulfonylamino, phenylsulfonylamino, butylsulfonylamino, n-octylsulfonylamino), a ureido group having from 1 to 20 carbon atoms (e.g. ureido, methylureido), a urethane group having from 2 to 20 carbon atoms (e.g. methoxycarbonylamino, ethoxycarbonylamino), an alkylthio group having from 1 to 20 carbon atoms (e.g. methylthio, ethylthio, octylthio), an arylthio group having from 6 to 20 carbon atoms (e.g. phenylthio, naphthylthio), an alkylsulfonyl group having from 1 to 20 carbon atoms (e.g. methylsulfonyl, butylsulfonyl), an arylsulfonyl group having from 7 to 20 carbon atoms (e.g. phenylsulfonyl, 2-naphthylsulfonyl), a sulfamoyl group having from 0 to 20 carbon atoms (e.g. non-substituted sulfamoyl, methylsulfamoyl), and a heterocyclic group (e.g. 4-pyridyl, piperidinyl, 2-furyl, furfuryl, 2-thienyl, 2-pyrrolyl, 2-quinolylmorpholino). However, the present invention is not limited by such substituents.

The compound represented by Formula (2) has an asymmetric carbon atom, and there are plural steric isomers. Among the isomers, an isomer having a structure represented by the following Formula (3) or Formula (4) is preferable.

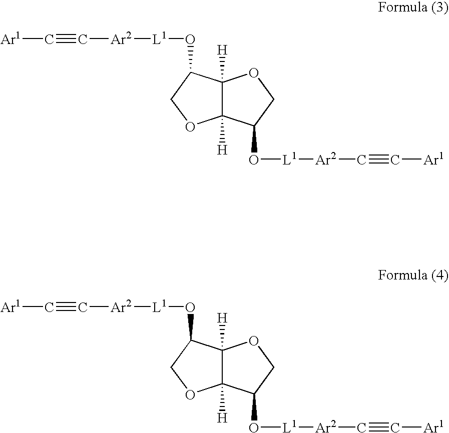

Ar¹, Ar² and L¹ in Formulas (3) and (4) have the same meanings as those of Ar¹, Ar² and L¹ in the formula (2), respectively.

-L¹-Ar²—C≡C—Ar¹ in Formulas (2) to (4) is not particularly limited as long as it has at least one fluorine atom and. As one of preferable aspects, the following Structural Formula (1) is exemplified.

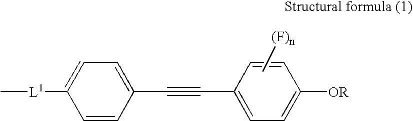

In the Structural Formula (1), —OR represents an alkoxy group having from 1 to 30 carbon atoms, and preferably an alkoxy group having from 1 to 15 carbon atoms. L¹ represents —C(═O)— or —CH₂—. And, n represents from 1 to 4.

As further specific -L¹-Ar²—C≡—Ar¹, the following structural formula (2) is exemplified as one of preferable structures.

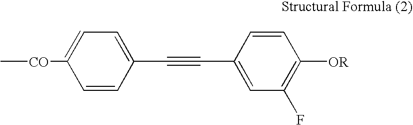

In the structural formula (2), —OR represents an alkoxy group having from 1 to 30 carbon atoms, preferably an alkoxy group having from 1 to 15 carbon atoms.

The following are examples of the chiral reagent used in the present invention.

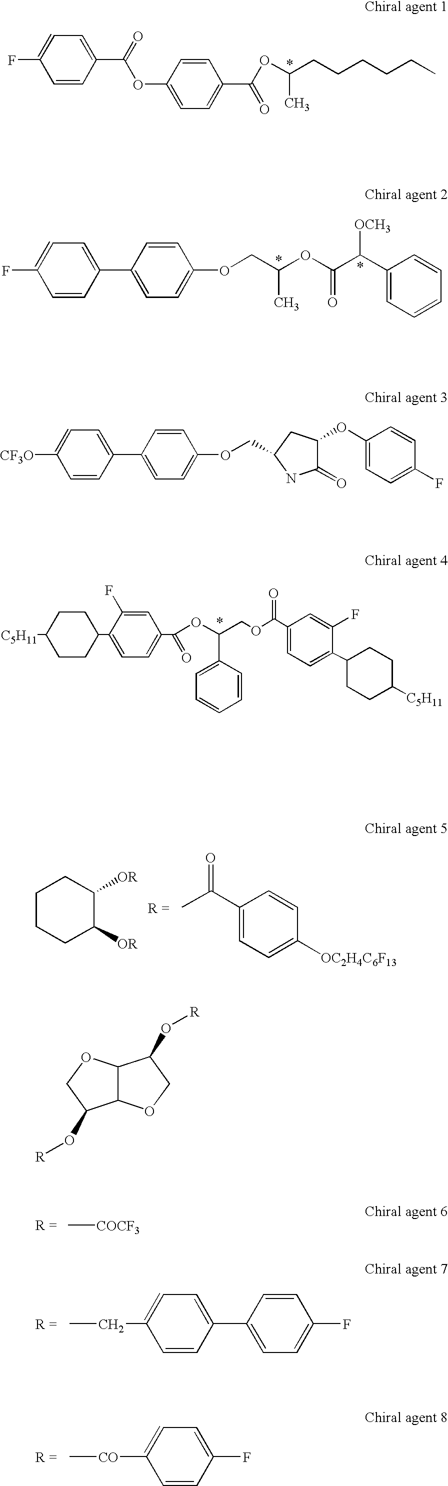

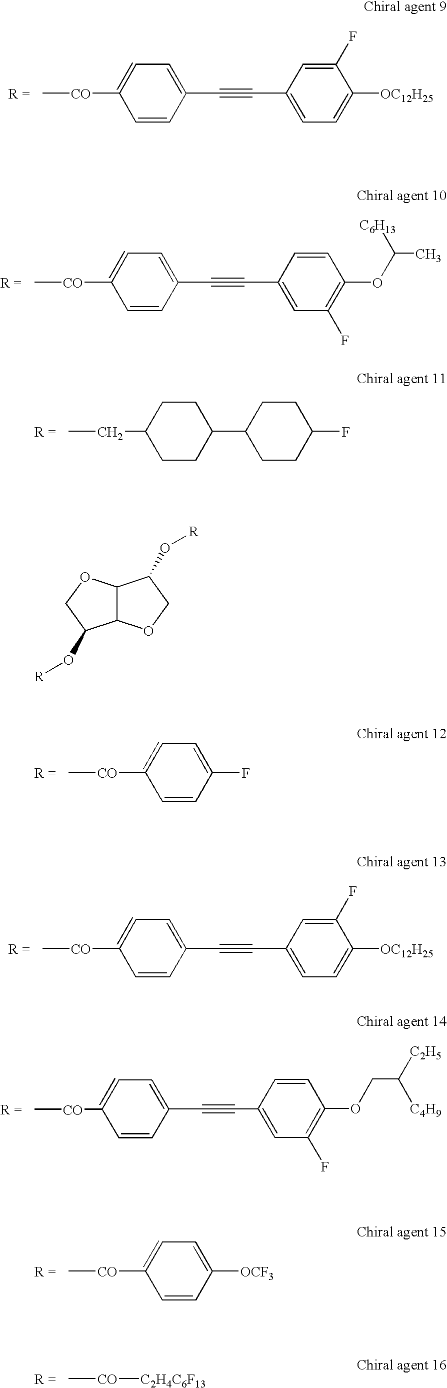

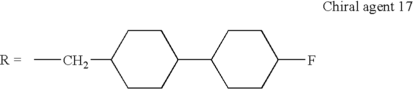

Since an addition amount of the chiral reagent in the liquid crystal composition is different depending on a display system of the cholecteric liquid crystal layer, the amount is preferably adjusted appropriately as described later. When the chiral reagent is added at an amount which is more than an optimal addition amount in each display system, a viscosity of the liquid crystal composition rises, and responsiveness is reduced, or the chiral reagent is easily precipitated from a host liquid crystal in some cases.

A plural chiral reagents may be used. Particularly the case, where the temperature dependency of a chiral pitch is reduced by combining use of a chiral pitch having positive temperature dependency and a chiral pitch having a negative temperature dependency, is preferable.

When a plural chiral reagents are used, commercially available other chiral reagents may be applied in combination with the above chiral reagent. Examples of the commercially available chiral reagent include R-1011 (manufactured by Merck), S-1011 (manufactured by Merck), R-811 (manufactured by Merck), S-811 (manufactured by Merck), CNL-611L (manufactured by ADEKA), CNL-617L (manufactured by ADEKA), and CNL-659L (manufactured by ADEKA).

### (Nematic Liquid Crystal)

The cholesteric liquid crystal usable in the present invention contains at least one nematic liquid crystal. The nematic liquid crystal refers to a liquid crystal exhibiting a nematic phase at 25° C.

When the nematic liquid crystal having anisotropy in a dielectric constant is used in the cholesteric liquid crystal layer, optical property may be changed due to the electric field. Since as an absolute value of dielectric constant anisotropy is greater, a threshold voltage becomes lower, this is preferable in saving of a consumed power. Therefore, an absolute value of dielectric constant anisotropy (Δ∈) is preferably 1.0 or larger, and more preferably 2.0 or larger. Dielectric constant anisotropy may be calculated by an external insertion method using a liquid crystal having the known dielectric constant anisotropy.

Dielectric constant anisotropy (Δ∈) is defined as a difference between dielectric constant anisotropy in a long axial direction of a liquid crystal molecule (∈∥) and dielectric constant anisotropy in a short axial direction of a liquid crystal molecule (∈⊥).

Δ∈=∈∥−∈⊥

Dielectric constant anisotropy (Δ∈) of the nematic liquid crystal used in the present invention may be positive or negative.

Refractive index anisotropy (Δn) of the nematic liquid crystal used in the present invention is preferably greater of an absolute value. Under the scattering state based on the random focal conic state, as Δn of the nematic liquid crystal is greater, the scattering state becomes higher, thereby improving display performance.

The refractive index anisotropy (Δn) as used herein is defined as a difference between a refractive index in a long axial direction of a liquid crystal molecule (n∥) and a refractive index in a short axial direction of a liquid crystal molecule (n⊥).

ti Δn=n∥−n⊥

Examples of the nematic liquid crystal compound include an azomethine compound, a cyanobiphenyl compound, cyanophenyl ester, phenyl ester, cyclohexane carboxylic acid phenyl ester, phenylcyclohexane, phenylpyrimidine, phenyldioxane, a tolan-based compound, and alkenylcyclohexylbenzonitrile. Liquid crystal compounds described in “Liquid Crystal Device Handbook” (edited by Japan Society for the Promotion of Science 142^{nd} Committee, The Nikkan Kogyo Shimbun, Ltd., 1989), p. 154-192, and p. 715-722 may be used.

Examples include liquid crystals of Merck (ZLI-1132, 4692, 4792, 6609, MLC-6267, 6284, 6287, 6288, 6406, 6422, 6423, 6425, 6435, 6437, 6609, 7700, 7800, 9000, 9100, 9200, 9300, 10000 etc.), liquid crystals of Chisso Corporation (LIXON5036xx, 5037xx, 5039xx, 5040xx, 5041xx etc.), and liquid crystals of ADEKA (HA-11757).

Particularly, a preferable nematic liquid crystal compound in a combination with the chiral reagent according to the present invention is a nematic liquid crystal having 1 or larger absolute value of dielectric constant anisotropy Δ∈. When Δ∈ is 1 or larger, a structure having a functional group (e.g. cyano group, fluorine atom) which may be polarized in a liquid molecular long axial direction is preferable and, when Δ∈ is smaller than −1, the structure is a structure having a functional group (e.g. cyano group, fluorine atom) which may be polarized in a liquid crystal short axial direction. When nematic liquid crystal compounds having such as structure are combined, it is possible to reduce the driving voltage.

### (Display System of Cholesteric Liquid Crystal Layer)

The cholesteric liquid crystal layer according to the present invention has a cholesteric liquid crystal composition containing the chiral reagent in the nematic liquid crystal. This cholesteric liquid crystal composition exhibits a cholesteric phase at 5° C. to 40° C.

In the display material of the present invention, the cholesteric liquid crystal layer is held between one pair of electrodes, at least one of which is a transparent electrode. By applying a voltage to this electrode, optical property of the liquid crystal is changed due to the electric filed, and display is changed.

A shape of the display material of the present invention is not particularly limited as long as the material has the cholesteric liquid crystal layer. For example, in any of (1) a sheet of the cholesteric liquid crystal composition, (2) a dispersion in which the cholesteric liquid crystal composition is dispersed in a polymer matrix, (3) a material obtained by adding a dichroic dye to the cholesteric liquid crystal composition to realize a guest-host liquid crystal mode, and (4) a display material exhibiting a structural color, obtained by adjusting an addition amount of the chiral reagent in the cholesteric liquid crystal composition to appropriately set a chiral pitch length, may be utilized. The driving voltage thereof may be reduced by applying the chiral reagent according to the present invention.

### (1) Sheet-Like Cholesteric Liquid Crystal Composition

When the nematic liquid crystal having greater Δn is used in the cholesteric liquid crystal composition, a scattering intensity in the scattering state is increased, and a contrast to a transparency degree in the oriented state is enhanced. In such the cholesteric liquid crystal composition, it is possible to switch between the white scattering state and the colorless transparent state.

In this case, an addition amount of the chiral reagent in the cholesteric liquid crystal composition is preferably from 1% by mass to 50% by mass, more preferably from 1.5% by mass to 30% by mass, and furthermore preferably from 2% by mass to 20% by mass.

### (2) Polymer Matrix Layer

The cholesteric liquid crystal layer may be a matrix layer in which the cholesteric liquid crystal composition is dispersed in polymer matrix.

As a method of forming the polymer matrix layer, (1) a method of coating a solution obtained by dissolving the cholesteric liquid crystal composition and the polymer(s) as a matrix on a substrate, and (2) a method of dissolving a polymer matrix liquid crystal composition and a polymer in a common solvent coating the solution on a substrate, and evaporating the solvent are preferable.

The polymer used in the polymer matrix layer is not particularly limited. As the polymer, for example: a water-soluble polymer such as siloxane polymer, methylcellulose, polyvinyl alcohol, polyoxyethylene, polyvinyl butyral, and gelatin; and water-insoluble polymers such as polyacrylates, polymethacrylates, polyamides, polyesters, polycarbonates, polyvinyl alcohol derivatives, a representative of which is vinyl acetate and polyvinyl butyral, cellulose derivatives such as triacetylcellulose, polyurethanes, and styrenes are used.

Among them, from a viewpoint of high compatibility with the liquid crystal, siloxane polymers, polyacrylates, and polymethacrylates are preferable. In addition, from a viewpoint of display stability with respect to vibration and impact, gelatin, and polyvinyl alcohol are preferable.

Further, in order to stabilize dispersion of the cholesteric liquid crystal composition, a surfactant may be used in the polymer matrix layer. The surfactant which may be applied to the present invention is not particularly limited, but a nonionic surfactant is preferable, and sorbitan fatty acid esters, polyoxyethylene fatty acid esters, polyoxyethylene alkyl ethers, and fluoroalkyl ethylene oxides are used.

In the polymer matrix layer, a mass ratio of the cholesteric liquid crystal composition, and the polymer as a medium is preferably from 1:10 to 10:1, and more preferably from 1:1 to 8:2.

In the display material of the present invention, a thickness of the polymer matrix layer is preferably from 1 μm to 50 μm, more preferably from 2 μm to 40 μm, and furthermore preferably from 5 μm to 30 μm.

In this case, an addition amount of the chiral reagent in the cholesteric liquid crystal composition is preferably from 1% by mass to 50% by mass, more preferably from 1.5% by mass to 30% by mass, and furthermore preferably from 2% by mass to 20% by mass.

### (3) Structural Color Layer

The cholesteric liquid crystal layer may be prepared as a layer exhibiting a structural color by adjusting an addition amount of the chiral reagent. The structural color means a medium that a refractive index thereof is periodically changed so that light of a specified wavelength may be Bragg-reflected, and a period thereof is approximately a size of a wavelength of light, and is preferably a submicron scale. A wavelength of reflecting light may be a wavelength of any of a visible region, an infrared region and an ultraviolet region.

An addition amount of the chiral reagent in the case of the structural color layer is appropriately adjusted depending on a structure of the chiral reagent and a combination with the nematic liquid crystal so that a pitch length is realized so as to obtain desired reflected light.

In this case, an addition amount of the chiral reagent in the cholesteric liquid crystal composition is preferably from 1% by mass to 50% by mass, more preferably from 1.5% by mass to 30% by mass, and furthermore preferably from 2% by mass to 20% by mass.

### (4) Guest-Host Liquid Crystal Layer

A dichroic dye may be added to the cholesteric liquid crystal composition. When the dichroic dye is added, a so-called guest-host liquid crystal mode is realized, and a display material which electrically controls absorption of light with the dichroic dye is obtained.

In this case, an addition amount of the chiral reagent in the cholesteric liquid crystal composition is preferably from 0.01% by mass to 20% by mass, more preferably from 0.1% by mass to 10% by mass, and furthermore preferably 0.3% by mass to 5% by mass.

### —Dichroic Dye—

In the present invention, the dichroic dye is defined as a compound which is dissolved in the liquid crystal, and has the function of absorbing light. The dichroic dye according to the present invention may be of any absorption maximum and any absorption band, and preferably has absorption maximum in a yellow region (Y), a magenta region (M) or a cyan region (C). In addition, two or more dichroic dye may be used, and it is preferable to use a mixture of dichroic dyes having absorption maximum in Y, M and C. A method of performing full color display by mixing a yellow dye, a magenta dye and a cyan dye is detailed in “Color Chemistry” (authored by Sumio Tokita, Maruzene Co., Ltd., 1982). As used herein, the yellow region is a range of from 430 to 490 nm, the magenta region is a range of from 500 to 580 nm, and the cyan region is a range of from 600 to 700 nm.

Next, a chromophore to be used for the dichroic dye of the present invention will be described.

Any chromophoric to group of the dichroic dye may be used, including, for example, azo dyes, anthraquinone dyes, perylene dyes, merocyanine dyes, azomethine dyes, phthaloperylene dyes, indigo dyes, azulene dyes, dioxadine dyes, polythiophene dyes, and phenoxadine dyes. Preferred are azo dyes, anthraquinone dyes, phenoxazine dyes, and particularly preferred are anthraquinone dyes, or phenoxazone dyes (phenoxazine-3-one).

The azo dyes may be any of monoazo dyes, bisazo dyes, trisazo dyes, tetrakisazo dyes, and pentakisazo dyes, and preferred are monoazo dyes, bisazo dyes, trisazo dyes.

The cyclic structure contained in the azo dye may be heterocyclic rings (quinone ring, pyridine ring, thiazole ring, benzothiazole ring, oxazole ring, benzooxazole ring, imidazole ring, benzoimidazole ring, pyrimidine ring, or the like) in addition to aromatic groups (benzene ring, naphthalene ring, or the like).

The substituent for the anthraquinone dye is preferably those containing an oxygen atom, a sulfur atom, or a nitrogen atom; and includes, for example, a alkoxy group, an aryloxy group, an alkylthio group, an arylthio group, an alkylamino group, and an arylamino group. The number of substitution of the substituent may be of any number and di-substitution, tri-substitution, or tetrakis-substitution is preferred, and di-substitution and tri-substitution are particularly preferred. The substitution of the substituent may be at any position and preferred structure is 1,4-di-substitution, 1,5-di-substitution, 1,4,5-tri-substitution, 1,2,4-tri-substitution, 1,2,5-tri-substitution, 1,2,4,5-tetra-substitution, and 1,2,5,6-tetra-substitution.

The substituent for the phenoxazone dye (phenaxazin-3-on) is preferably those containing an oxygen atom, a sulfur atom, or a nitrogen atom; and includes, for example, an alkoxy group, an aryloxy group, an alkylthio group, an arylthio group, an alkylamino group, and an arylamino group.

From a viewpoint that both of high solubility in the nematic liquid crystal and a high order parameter are realized, it is preferable that the dichroic dye used in the display material of the present invention has a substituent represented by at least one of the following Formula (1).

-(Het)ⱼ-{(B¹)ₚ-(Q¹)_{q}-(B²)ᵣ}ₙ—C¹ Formula (1)

In Formula (1), Het is an oxygen atom or a sulfur atom; B¹ and B² each independently represent an arylene group, a heteroarylene group or a bivalent cyclic aliphatic hydrocarbon group; Q¹ represents a bivalent linking group; C¹ represents an alkyl group, a cycloalkyl group, an alkoxy group, an alkoxycarbonyl group, an acyl group, or an acyloxy group; j represents 0 or 1; p, q and r each independently represent an integer from 0 to 5; n represents an integer from 1 to 3; (p+r)×n is an integer from 3 to 10; when p is 2 or larger, two or more groups represented by B¹ may be the same or different; when q is 2 or larger, two or more groups represented by Q¹ may be the same or different; when r is 2 or larger, two or more groups represented by B² may be the same or different; and when n is 2 or larger, two or more groups represented by {(B¹)ₚ-(Q¹)_{q}-(B²)ᵣ} may be the same or different.

Het is an oxygen atom or a sulfur atom, particularly preferably a sulfur atom.

B¹ and B² each independently represent an arylene group, a heteroarylene group, or a bivalent cyclic aliphatic hydrocarbon group, and any group may have or not have a substituent.

The arylene group represented by B¹ and B² is preferably an arylene group having 6 to 20 carbon atoms, and more preferably 6 to 10 carbon atoms. Specific examples of preferred arylene group include, for example, a phenylene group, a naphthalene group, and an anthracene group, more preferably a phenylene group and a substituted phenylene group, and furthermore preferably 1,4-phenylene group.

The heteroarylene group represented by B¹ and B² is preferably an heteroarylene group having 1 to 20 carbon atoms, and more preferably an heteroarylene group having 2 to 9 carbon atoms. Specific examples of preferred heteroarylene group include, for example, a group including pyridine ring, quinoline ring, isoquinoline ring, pyrimidine ring, pyrazine ring, thiophene ring, furan ring, oxazole ring, thiazole ring, imidazole ring, pyrazole ring, oxadiazole ring, thiadiazole ring, and triazole ring, as well as a heteroarylene group obtained by eliminating hydrogen atoms each by one from two carbon atoms in a condensed ring formed by ring condensation thereof.

The bivalent cycloaliphatic hydrocarbon group represented by B¹ and B² is preferably a bivalent cycloaliphatic hydrocarbon group having preferably 3 to 20 carbon atoms, and more preferably 4 to 10 carbon atoms. Specific examples of preferred bivalent cycloaliphatic hydrocarbon group include a cyclohexanediyl and cyclopentanediyl, more preferably cyclohexane-1,2-diyl, cyclohexane-1,3-diyl, cyclohexane-1,4-diyl, and cyclopentane-1,3-diyl, and particularly preferably (E)-cyclohexane-1,4-diyl.

The arylene group, heteroarylene group, and bivalent cyclic aliphatic hydrocarbon group represented by B¹ and B² may further have a substituent, and the substituent includes the following substituent group V.

### (Substituent Group V)

Halogen atoms (for example, chlorine, bromine, iodine, fluorine), a mercapto group, a cyano group, a carboxyl group, a phosphoric group, a sulfo group, a hydroxy group, a carbamoyl group having 1 to 10 carbon atoms, preferably 2 to 8 carbon atoms, and more preferably 2 to 5 carbon atoms (for example, methyl carbamoyl, ethyl carbamoyl, morpholinocarbamoyl), a sulfamoyl group having 0 to 10 carbon atoms, preferably 2 to 8 carbon atoms, and more preferably 2 to 5 carbon atoms (for example, methylsulfamoyl, ethylsulfamoyl, piperidinosulfamoyl), a nitro group, an alkoxy group having 1 to 20 carbon atoms, preferably 1 to 10 carbon atoms, and more preferably 1 to 8 carbon atoms (for example, methoxy, ethoxy, 2-methoxyethoxy, 2-phenylethoxy), an aryloxy group having 6 to 20 carbon atoms, preferably 6 to 12 carbon atoms, and more preferably 6 to 10 carbon atoms (for example, phenoxy, p-methylphenoxy, p-chlorophenoxy, naphthoxy), an acyl group having 1 to 20 carbon atoms, preferably 2 to 12 carbon atoms, and more preferably 2 to 8 carbon atoms (for example, acethy, benzoyl, trichloroacetyl), an acyloxy group having 1 to 20 carbon atoms, preferably having 2 to 12 carbon atoms, and more preferably 2 to 8 carbon atoms (for example, acetyloxy, benzoyloxy), an acylamino group having 1 to 20 carbon atoms, preferably having 2 to 12 carbon atoms, and more preferably 2 to 8 carbon atoms (for example, acetylamino), a sulfonyl group having 1 to 20 carbon atoms, preferably 1 to 10, and more preferably 1 to 8 carbon atoms (for example, methanesulfony, ethanesulfonyl, benzenesulfonyl), a sulfinyl groups having 1 to 20 carbon atoms, preferably 1 to 10, and more preferably 1 to 8 carbon atoms (for example, methanesulfinyl, ethanesulfinyl, benzenesulfinyl), a substituted or unsubstituted amino group having 1 to 20 carbon atoms, preferably 1 to 12 carbon atoms, and more preferably 1 to 8 carbon atoms (for example, amino, methylamino, dimethylamino, benzylamino, anilino, diphenylamino, 4-methylphenylamino, 4-ethylphenylamino, 3-n-propylphenylamino, 4-n-propylphenylamino, 3-n-butylphenylamino, 4-n-butylphenylamino, 3-n-pentylphnylamino, 4-n-pentylphenylamino, 3-trifluoromethylphenylamino, 4-trifluoromethylphenylamino, 2-pyridylamino, 3-pyridylamino, 2-thiazolylamino, 2-oxazolylamino, N,N-methylphenylamino, N,N-ethylphenylamino), an ammonium group having 0 to 15 carbon atoms, preferably 3 to 10 carbon atoms, more preferably 3 to 6 carbon atoms (for example, trimethylammonium, triethylammonium), a hydrazino group having 0 to 15 carbon atoms, preferably 1 to 10 carbon atoms, and more preferably 1 to 6 carbon atoms (for example, trimethylhydrazino), an ureido group having 1 to 15 carbon atoms, preferably 1 to 10 carbon atoms, and more preferably 1 to 6 carbon atoms (for example, ureido group, N,N-dimethylureido group), an imide group having 1 to 15 carbon atoms, preferably 1 to 10 carbon atoms, and more preferably 1 to 6 carbon atoms (for example, succinimide group), an alkylthio group having 1 to 20 carbon atoms, preferably 1 to 12 carbon atoms, and more preferably 1 to 8 carbon atoms (for example, methylthio, ethylthio, propylthio), an arylthio group having 6 to 80 carbon atoms, preferably 6 to 40 carbon atoms, and more preferably 6 to 30 carbon atoms (for example, phenylthio, p-methylphenylthio, p-chlorophenylthio, 2-pyridylthio, 1-naphthylthio, 2-naphthylthio, 4-propylcyclohexyl-4′-biphenylthio, 4-butylcyclohexyl-4′-biphenylthio, 4-pentylcyclohexyl-4′-biphenylthio, 4-propylphenyl-2-ethynyl-4′-biphenylthio), a heteroarylthio group having 1 to 80 carbon atoms, preferably 1 to 40 carbon atoms, and more preferably 1 to 30 carbon atoms (for example, 2-pyridylthio, 3-pyridylthio, 4-pyridylthio, 2-quinolylthio, 2-furilthio, 2-pyrrolylthio), an alkoxycarbonyl groups having 2 to 20 carbon atoms, preferably 2 to 12 carbon atoms, and more preferably 2 to 8 carbon atoms (for example, methoxycarbonyl, ethoxycarbonyl, 2-benzyloxycarbonyl), an aryloxycarbonyl group having 6 to 20 carbon atoms, preferably 6 to 12 carbon atoms, and more preferably 6 to 10 carbon atoms (for example, phenoxycarbonyl), an unsubstituted alkyl group having 1 to 18 carbon atoms, preferably 1 to 10 carbon atoms, and more preferably 1 to 5 carbon atoms (for example, methyl ethyl, propyl, butyl), a substituted alkyl group having 1 to 18 carbon atoms, preferably 1 to 10 carbon atoms, and more preferably 1 to 5 carbon atoms {for example, hydroxymethyl, trifluoromethyl, benzyl, carboxyethyl, ethoxycarbonylmethyl, acetylaminomethyl, moreover, in here, an unsaturated hydrocarbon group having 2 to 18 carbon atoms, preferably 3 to 10 carbon atoms, and more preferably 3 to 5 carbon atoms (for example, a vinyl group, an ethynyl group, an 1-cyclohexenyl group, a benzylidyne group, a benzylidene group) will be included in the substituted alkyl groups), a substituted or unsubstituted aryl group having 6 to 20 carbon atoms, preferably 6 to 15 carbon atoms, and more preferably 6 to 10 carbon atoms (for example, phenyl, naphthyl, p-carboxyphenyl, p-nitrophenyl, 3,5-dichlorophenyl, p-cyanophenyl, m-fluorophenyl, p-tolyl, 4-propylcyclohexyl-4′-biphenyl, 4-butylcyclohexyl-4′-biphenyl, 4-pentylcyclohexyl-4′-biphenyl, 4-propylphenyl-2-ethynyl-4′-biphenyl), a substituted or unsubstituted heteroaryl group having 1 to 20 carbon atoms, preferably 2 to 10 carbon atoms, and more preferably 4 to 6 carbon atoms (for example, pyridyl, 5-methylpyridyl, thienyl, furyl, morpholino, tetrahydrofurfuryl).

Those substituent groups V may have a structure in which a benzene ring or a naphthalene ring is condensed. Further, the substituent illustrated by the explanation for V explained so far may further be substituted on the substituents described above.

Among the substituent groups V, a preferred substituents include an alkyl group, an aryl group, an alkoxy group, an aryloxy group, halogen atom, amino group, a substituted amino group, a hydroxy group, or an alkylthio group, and further preferably an alkyl group, an aryl group, or halogen atom.

Q¹ represents a divalent linking group, preferably a linking group formed by at least one atom selected from the group consisting of a carbon atom, a nitrogen atom, a sulfur atom and an oxygen atom. Examples of the divalent linking group represented by Q¹ include divalent linking groups having from 0 to 60 carbon atoms constituted by at least one group selected from the group consisting of an alkylene group having preferably from 1 to 20 carbon atoms, and more preferably 1 to 10 (e.g. methylene, ethylene, propylene, butylene, pentylene, cyclohexyl-1,4-diyl), an alkenylyne group having preferably from 2 to 20 carbon atoms, and more preferably 2 to 10 carbon atoms (e.g. ethenylene), an alkynylene group having preferably from 2 to 20 carbon atoms, and more preferably 2 to 10 carbon atoms (e.g. ethynylene), an amido group, an ether group, an ester group, a sulfonamido group, a sulfonic acid ester group, an ureido group, a sulfonyl group, a sulfinyl group, a thioether group, a carbonyl group, a —NR— group (wherein R represents a hydrogen atom, an alkyl group, or an aryl group; an alkyl group represented by R is an alkyl group having preferably from 1 to 20 carbon atoms, and more preferably 1 to 10 carbon atoms; an aryl group represented by R is an aryl group having preferably from 6 to 14 carbon atoms, and more preferably 6 to 10 carbon atoms), an azo group, an azoxy group, a heterocyclic divalent group (a heterocyclic divalent group having preferably from 2 to 20 carbon atoms, and more preferably 4 to 10 carbon atoms, for example, a piperazin-1,4-diynyl group).

As a bivalent linking group represented by Q¹, an alkylene group, an alkenylene group, an alkynylene group, an ether group, a thioether group, an amide group, an ester group, a carbonyl group, and a combination of two or more of them are preferable.

Q¹ may further have a substituent, and the substituent group V is enumerated as the substituent.

C¹ represents an alkyl group, a cycloalkyl group, an alkoxy group, an alkoxycarbonyl group, an acyl group, or an acyloxy group. The alkyl group, the cycloalkyl group, the alkoxy group, the alkoxycarbonyl group, the acyl group, or the acyloxy group, which is represented by C¹, is also included each group which has a substituent.

C¹ preferably represents an alkyl or a cycloalkyl group having 1 to 30 carbon atoms, more preferably 1 to 12 carbon atoms, and furthermore preferably 1 to 8 carbon atoms (for example, methyl, ethyl, propyl, butyl, t-butyl, i-butyl, s-butyl, pentyl, t-pentyl, hexyl, heptyl, octyl, cyclohexyl, 4-methylcyclohexyl, 4-ethylcyclohexyl, 4-propylcyclohexyl, 4-butylcyclohexyl, 4-pentylcyclohexyl, hydroxymethyl, trifluoromethyl, benzyl), an alkoxy group having 1 to 20 carbon atoms, more preferably 1 to 10 carbon atoms, and furthermore preferably 1 to 8 carbon atoms (for example, methoxy, ethoxy, 2-methoxyethoxy, 2-phenylethoxy), an acyloxy group having 1 to 20 carbon atoms, more preferably 2 to 12 carbon atoms, and further preferably 2 to 8 carbon atoms (for example, acetyloxy, benzoyloxy), an acyl group having 1 to 30 carbon atoms, more preferably 1 to 12 carbon atoms, and furthermore 1 to 8 carbon atoms (for example, acetyl, formyl, pivaloyl, 2-chloroacetyl, stearoyl, benzoyl, p-n-octyloxyphenylcarbonyl), or an alkoxycarbonyl group having 2 to 20 carbon atoms, more preferably 2 to 12 carbon atoms, and furthermore preferably 2 to 8 carbon atoms (for example, methoxycarbonyl, ethoxycarbonyl, 2-benzyloxycarbonyl.

C¹ represents particularly preferably an alkyl group or an alkoxy group, and more preferably ethyl, propyl, butyl, pentyl, hexyl, or trifluoromethoxy.

C¹ may further have a substituent, and the substituent group V is enumerated as the substituent.

A substituent for the alkyl group represented by C¹ preferably includes, among the substituent group V, a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, or an aryloxycarbonyl group.

A substituent for the cycloalkyl group represented by C¹ preferably includes, among the substituent group V, a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, an aryloxycarbonyl group, and an alkyl group.

A substituent for the alkoxy group represented by C¹ preferably includes, among the substituent group V, a halogen atom (particularly, fluorine atom), a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, and an aryloxycarbonyl group.

A substituent for the alkoxycarbonyl group represented by C¹ preferably includes, among the substituent group V, a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, or an aryloxycarbonyl group.

A substituent for the acyl group represented by C¹ preferably includes, among the substituent group V, a halogen atom, a cyano group, a hydroxy group, a carbamoyl group, an alkoxy group, an aryloxy group, an acyl group, an acyloxy group, an acylamino group, an alkylthio group, an arylthio group, a heteroarylthio group, an alkoxycarbonyl group or an aryloxycarbonyl group.

A substituent for the acyloxy group represented by C¹ preferably includes, among the substituent group V, a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, or an aryloxycarbonyl group.

j represents 0 or 1, and preferably 0.

p, q and r each independently represent an integer from 0 to 5, and n represents an integer from 1 to 3. The total number of the groups represented by B¹ and B², that is, (p+r)×n is an integer from 3 to 10, more preferably an integer from 3 to 5. when p, q and r each are 2 or larger; two or more groups represented by B¹ may be the same or different; when q is 2 or larger, two or more groups represented by Q¹ may be the same or different; when r is 2 or larger, two or more groups represented by B² may be the same or different; when n is 2 or larger, two or more groups represented by {(B¹)ₚ-(Q¹)_{q}-(B²)ᵣ} may be the same or different.

Preferable combinations of p, q, r, and n will be described as follows.

(i) p=3, q=0, r=0, n=1

(ii) p=4, q=0, r=0, n=1

(iii) p=5, q=0, r=0, n=1

(iv) p=2, q=0, r=1, n=1

(v) p=2, q=1, r=1, n=1

(vi) p=1, q=1, t=2, n=1

(vii) p=3, q=1, r=1, n=1

(viii) p=2, q=0, r=2, n=1

(ix) p=1, q=1, r=1, n2

(x) p=2, q=1, r=1, n=2

Particularly preferable combinations are (i) p=3, q=0, r=0, n=1; (iv) p=2, q=0, r=1, n=1; and (v) p=2, q=1, r=1, n=1.

—{(B¹)ₚ-(Q¹)_{q}-(B²)ᵣ}ₙ—C¹ is preferable to contain a partial structure to exhibit the liquid crystal property. Herein, the liquid crystal may be any phase, preferably is a nematic liquid crystal, a smectic liquid crystal, and a discotic liquid crystal, and particularly preferably a nematic liquid crystal.

Specific examples of —{(B¹)ₚ-(Q¹)_{q}-(B²)ᵣ}ₙ—C¹ are shown below, but the present invention should not be limited to them (in the following chemical formulas, the wavy line shows the connecting position).

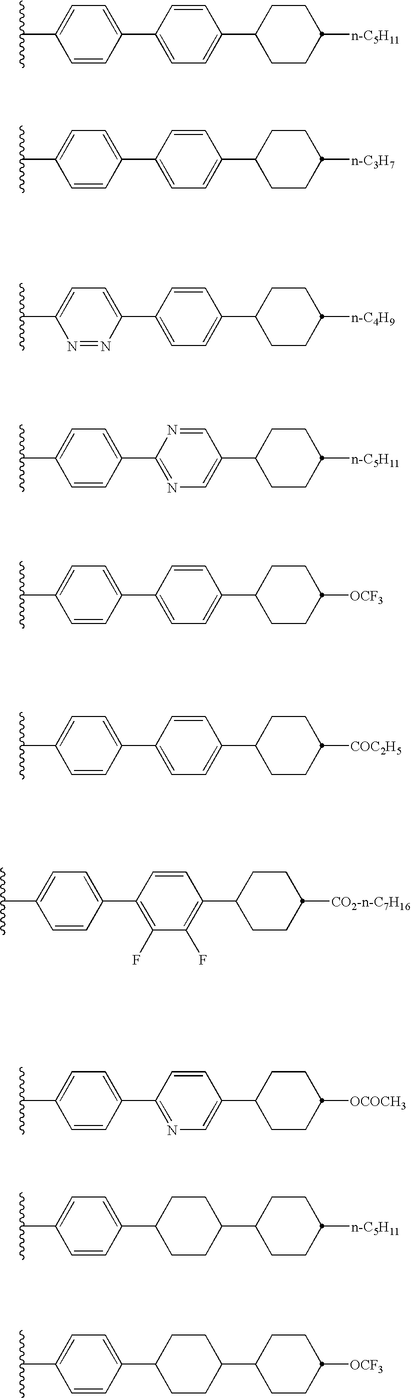

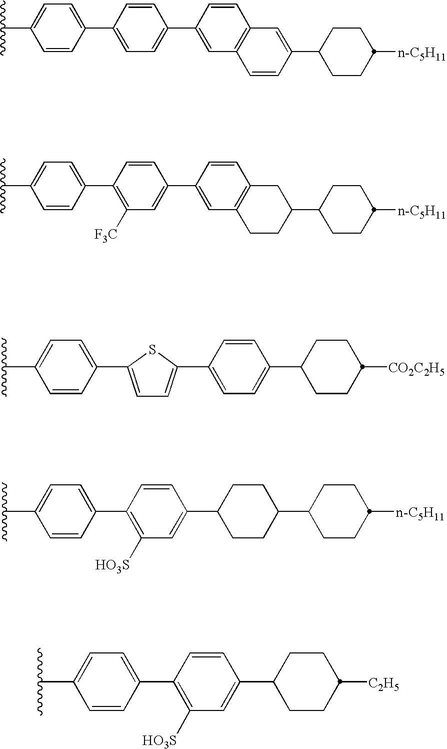

The dichroic dye used in the present invention has preferably one or more, more preferably 1 to 8, furthermore preferably 1 to 4, and particularly preferably 1 or 2 substituents represented by —{(B¹)ₚ-(Q¹)_{q}-(B²)ᵣ}ₙ—C¹.

A preferred structure of the substituent represented by Formula (1) includes combinations described below.

[1] A structure in which Het represents sulfur atom, B¹ represents an aryl group or a heteroaryl group, B² represents cyclohexane-1,4-diyl group, C¹ represents an alkyl group, and j=1, p=1, q=0, r=2, and n=1.
[2] A structure in which Het represents sulfur atom, B¹ represents an aryl group or a heteroaryl group, B² represents cyclohexane-1,4-diyl group, C¹ represents an alkyl group, and j=1, p=1, q=0, r=2 and n=1.

Especially preferred structures are:

[1] a structure represented by the following Formula (a-1), in which Het represents sulfur atom, B¹ represents a 1,4-phenylene group, B² represents trans-cyclohexyl group, C¹ represents an alkyl group (preferably, methyl, ethyl, propyl, butyl, pentyl, or hexyl), and j=1, p=2, q=0, r=1 and n=1, and
[2] a structure represented by the following Formula (a-2), in which Het represents a sulfur atom, B¹ represents 1,4-phenylene, B² represents trans-cylohexane-1,4-diyl, C¹ represents an alkyl group (preferably, methyl, ethyl, propyl, butyl, pentyl, or hexyl), and j=1, p=1, q=0, r=2 and n=1.

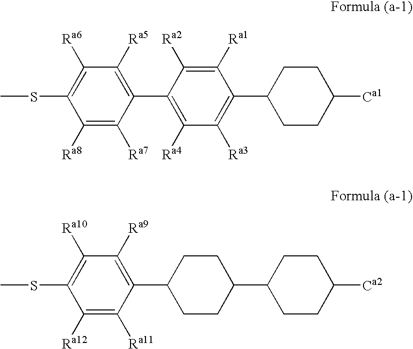

In Formulae (a-1) and (a-2), R^{a1} to R^{a12} each independently represents a hydrogen atom or a substituent. The substituent includes, for example, a substituent selected from the substituent group V.

R^{a1} to R^{a12} each independently represents preferably a hydrogen atom, a halogen atom (particularly, fluorine atom), an alkyl group, an aryl group, and an alkoxy group. Among the alkyl group, alkyl group, and alkoxy group represented by R^{a1} to R^{a12}, preferred are those identical with the alkyl group, aryl group, and alkoxy group described for the substituent group V.

In Formulae (a-1) and (a-2), C^{a1} and C^{a2} each independently represents an alkyl group, and an alkyl group having preferably 1 to 20 carbon atoms, more preferably 1 to 10 carbon atoms, and furthermore preferably methyl, ethyl, propyl, butyl, pentyl, hexyl, heptyl, octyl, or nonyl.

Among the Formulas (a-1) and (a-2), a substituent represented by the Formula (1) is preferably those containing C^{a1} and C^{a2} which are each a long chain alkyl group having from 3 to 10-carbon atoms, because the solubility to the host crystal is improved, thereby increasing the amount of absorbs light in the colored state, and the fact is preferred for the display materials.

The azo dye may be any of monoazo dye, bisazo dye, trisazo dye, tetrakisazo dye, or pentakisazo dye, and preferably a monoazo dye, bisazo dye and trisazo dye.

A ring structure contained in the azo dye includes, in addition to aromatic groups (benzene ring, naphthalene ring, or the like), hetero rings (quinoline ring, pyridine ring, thiazole ring, benzothiazole ring, oxazole ring, benzooxazole ring, imidazole ring, benzoimidazole ring, pyrimidine ring, or the like).

The substituent for the anthraquione dye preferably includes those containing an oxygen atom, sulfur atom or nitrogen atom, for example, an alkoxy group, an aryloxy group, an alkylthio group, an arylthio group, an alkylamino group, and an arylamino group.

While the number of substitution for the substituent may be of any number, di-substitution, tri-substitution, and tetra-substitution are preferred, and di-substitution, tri-substitution are particularly preferred. The substitution of the substituent may be at any position adopted, and preferred are 1,4-di-substitution, 1,5-di-substitution, 1,4,5-tri-substitution, 1,2,4-tri-substitution, 1,2,5-tri-substitution, 1,2,4,5-tetra-substitution, and 1,2,5,6-tetra-substitution structure.

The anthraquinone dye is more preferably a compound represented by the following Formula (5), and the phenoxazone dye is more preferably a compound represented by the following Formula (6).

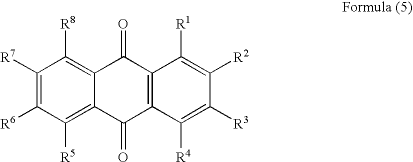

In Formula (5), at least one of R¹, R², R³, R⁴, R⁵, R⁶, R⁷ and R⁸ represents -(Het)ⱼ—{(B¹)ₚ-(Q¹)_{q}-(B²)ᵣ}ₙ—C¹, and others each independently represents hydrogen atom or a substituent.

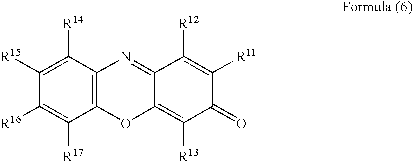

In Formula (6), at least one or more of R¹¹, R¹², R¹³, R¹⁴, R¹⁵, R¹⁶, and R¹⁷, represents (Het)ⱼ-{(B¹)ₚ-(Q¹)_{q}-(B²)ᵣ}ₙ—C¹, and the others each independently represents hydrogen atom or a substituent.

Here, Het, B¹, B², Q¹, j, p, q, r, n, and C¹ have the same definitions as Het, B¹, B², Q¹, j, p, q, r, n, and C¹ in Formula (1), respectively.

In Formula (5), the above substituents represented by R¹, R², R³, R⁴, R⁵, R⁶, R⁷, and R⁸ include the substituent group V, preferably include arylthio groups having 6 to 80 carbon atoms, more preferably 6 to 40 carbon atoms, and further preferably 6 to 30 carbon atoms (for example, phenylthio, p-methylphenylthio, p-chlorophenylthio, 4-methylphenylthio, 4-ethylphenylthio, 4-n-propylphenylthio, 2-n-butylphenylthio, 3-n-butylphenylthio, 4-n-butylphenylthio, 2-t-butylphenylthio, 3-t-butylphenylthio, 4-t-butylphenylthio, 3-n-pentylphenylthio, 4-n-pentylphenylthio, 4-amylpentylphenylthio, 4-hexylphenylthio, 4-heptylphenylthio, 4-octylphenylthio, 4-trifluoromethylphenylthio, 3-trifluoromethylphenylthio, 2-pyridylthio, 1-naphthylthio, 2-naphthylthio, 4-propylcyclohexyl-4′-biphenylthio, 4-butylcyclohexyl-4′-biphenylthio, 4-pentylcyclohexyl-4′-biphenylthio, 4-propylphenyl-2-ethynyl-4′-biphenylthio), a heteroarylthio group having 1 to 80 carbon atoms, more preferably 1 to 40 carbon atoms, and further preferably 1 to 30 carbon atoms (for example, 2-pyridylthio, 3-pyridylthio, 4-pyridylthio, 2-quinolylthio, 2-furylthio, 2-pyrrolylthio), a substituted or unsubstituted alkylthio groups (for example, methylthio, ethylthio, butylthio, phenethylthio), a substituted or unsubstituted amino group (for example, amino, methylamino, dimethylamino, benzylamino, anilino, diphenylamino, 4-methyphenylamino, 4-ethylphenylamino, 3-n-propylphenylamino, 4-n-propylphenylamino, 3-n-butylphenylamino, 4-n-butylphenylamino, 3-n-pentylphenylamino, 4-n-pentylphenylamino, 3-trifluoromethyphenylamino, 4-trifluoromethylphenylamino, 2-pyridylamino, 3-pyridylamino, 2-thiazolylamino, 2-oxazolylamino, N,N-methylphenylamino, N,N-ethylphenylamino), a halogen atom (for example, fluorine atom, chlorine atom), a substituted or unsubstituted alkyl group (for example, methyl, trifluoromethyl), a substituted or unsubstituted alkoxy group (for example, methoxy, trifluoromethoxy), a substituted or unsubstituted aryl group (for example, phenyl), a substituted or unsubstituted heteroaryl group (for example, 2-pyridyl), a substituted or unsubstituted aryloxy group (for example, phenoxy), a substituted or unsubstituted heteroaryloxy group (for example, 3-thienyloxy), and the like.

R¹, R², R³, R⁴, R⁵, R⁶, R⁷, and R⁸ are preferably a hydrogen atom, a fluorine atom, a chlorine atom, an arylthio group, an alkylthio group, an amino group, an alkylamino group, an arylamino group, an alkyl group, an aryl group, an alkoxy group, or an aryloxy group, and particularly preferably a hydrogen atom, a fluorine atom, an arylthio group, an alkylthio group, an amino group, an alkylamino group, or an arylamino group. These groups may be substituted or unsubstituted.

Moreover, in Formula (5), at least one of R¹, R⁴, R⁵, and R⁸ is further preferably -(Het)ⱼ-{(B¹)ₚ-(Q¹)_{q}-(B²)ᵣ}ₙ—C¹.

In Formula (6), the substituents represented by R¹¹, R¹², R¹³, R¹⁴, R¹⁵, R¹⁶, and R¹⁷ are a halogen atom, an alkyl group, an aryl group, an alkylthio group, an arylthio group, a heterocyclicthio group, a hydroxyl group, an alkoxy group, an aryloxy group, a carbamoyl group, an acyl group, an aryloxycarbonyl group, an alkoxycarbonyl group, and an amido group, and particularly preferably hydrogen atom, a halogen atom, an alkyl group, an arylthio group, or an amido group.

R¹⁶ is preferably an amino group (include an alkylamino group and an arylamino group), a hydroxyl group, a mercapto group, an alkylthio group, an arylthio group, an alkoxy group, or an aryloxy group, and particularly preferably an amino group.

Specific examples of the dichroic dyes which can be used in the present invention will be shown below, but the present invention should not be limited at all by the following specific examples.

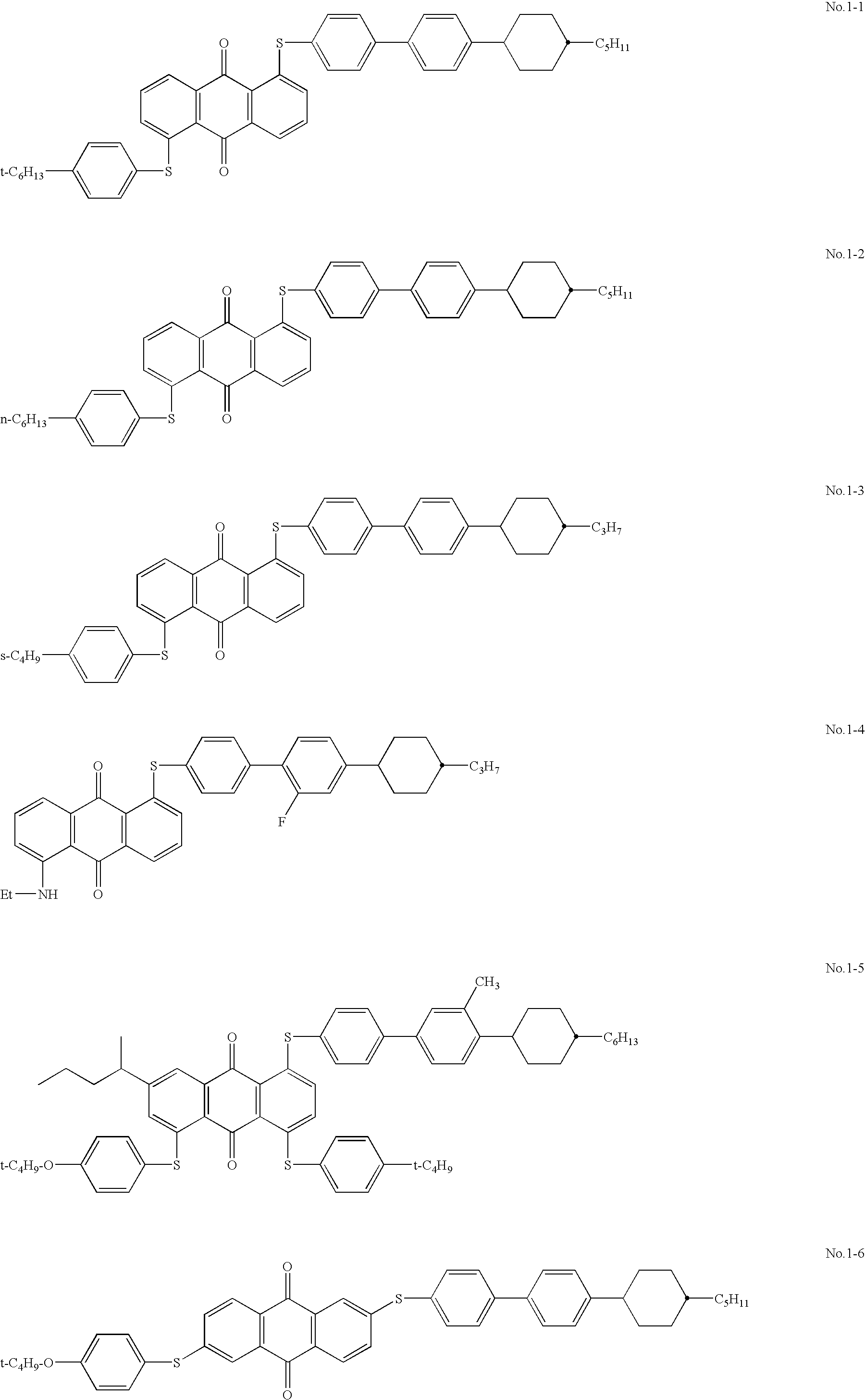

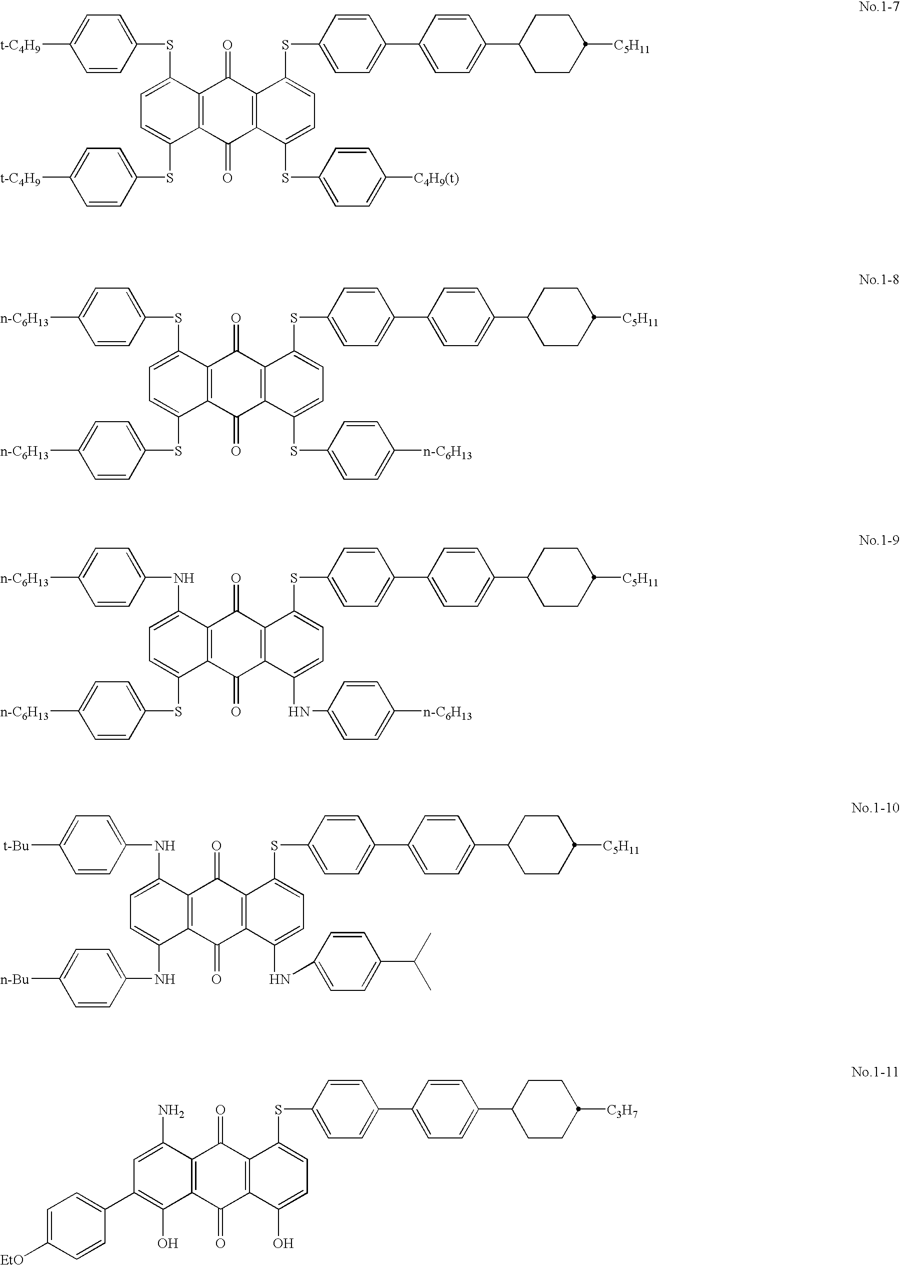

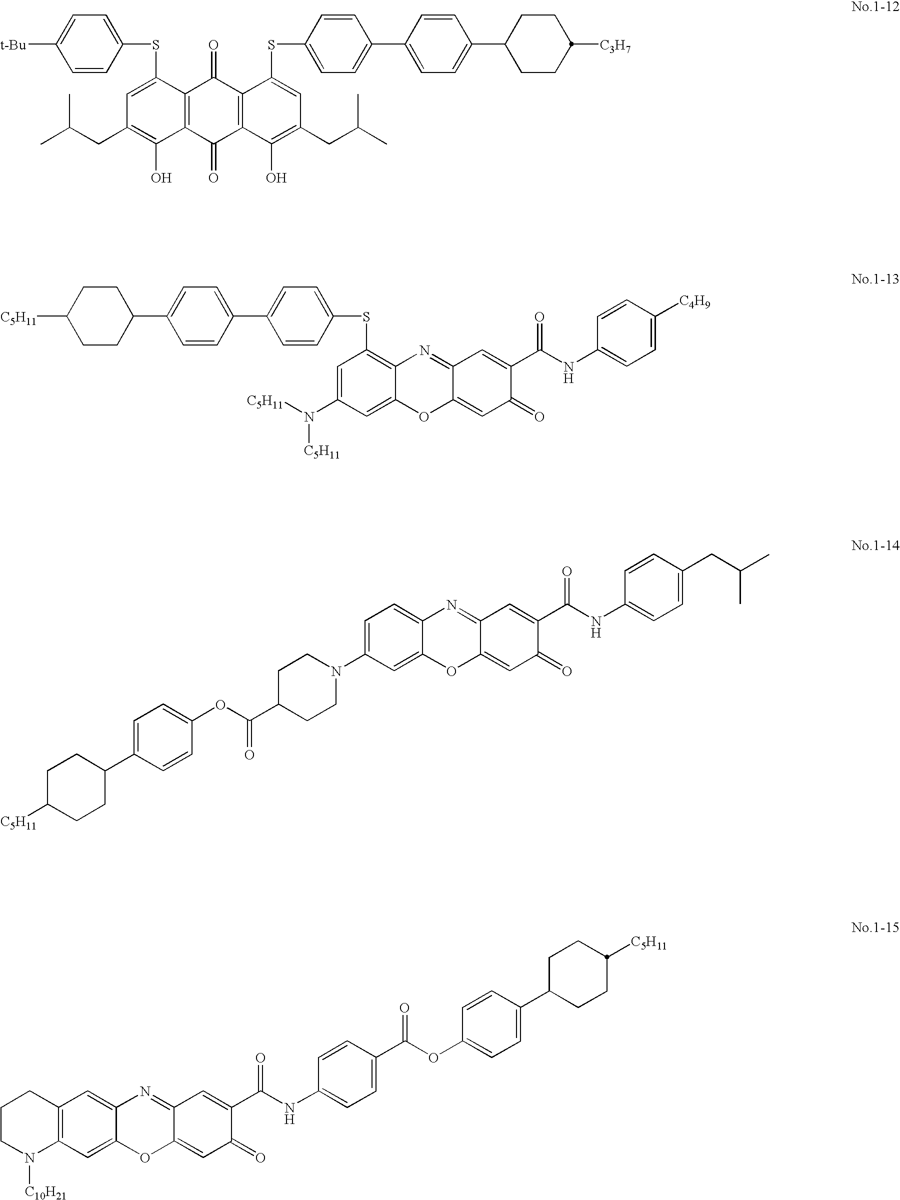

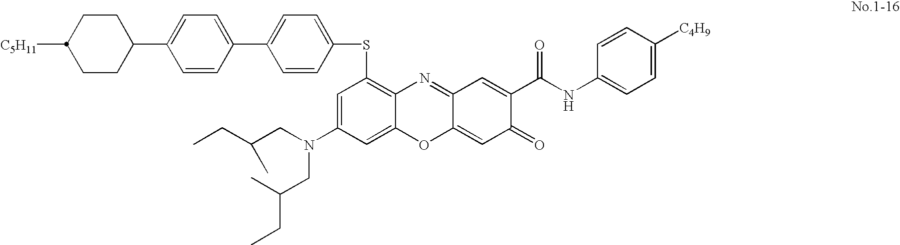

Specific examples of the azo-based dichroic dyes are shown below but the present invention is not restricted to the following specific examples.

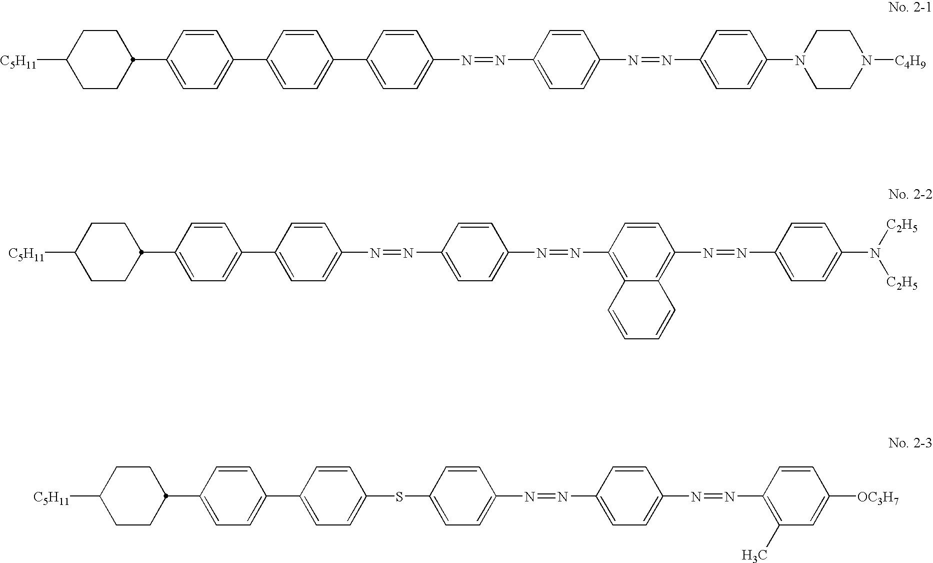

Specific examples of the dioxadine type dichroic dyes and merocyanine type dichroic dyes usable in the present invention are shown below but the present invention is not restricted to the following specific examples.

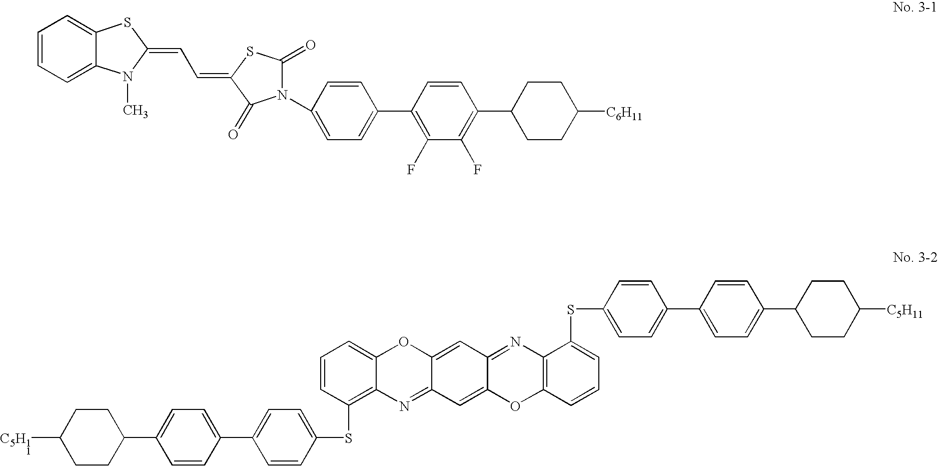

The dichroic dyes which have substituents and are represented by Formula (1) can be synthesized by combining the known methods. For example, they can be synthesized according to the methods described in JP-A No. 2003-192664 and the like.

In the guest-host system, when the liquid crystal having positive dielectric constant anisotropy is oriented parallel, since the liquid crystal is oriented parallel at application of no voltage, the dichroic dye also becomes parallel to absorbs light. On the other hand, since a liquid crystal molecule is oriented vertical at application of a voltage, the dichroic dye is also oriented vertical and, as a result, light becomes permeating therethrough. That is, it is brought into the transparent state at application of a voltage, and it is brought into the colored state at application of no voltage.

When dielectric constant anisotropy orientates the negative liquid crystal vertical, since the liquid crystal is oriented vertical at application of no voltage, the dichroic dye is also oriented vertical, and light is permeated therethrough without any absorption. On the other hand, since the liquid crystal molecule is oriented parallel at application of a voltage, the dichroic dye is also oriented parallel and, as a result, it becomes to absorb light. That is, it is brought into the transparent state at application of no voltage, and it is brought into the colored state at application of a voltage.

A content of the liquid crystal and the dichroic dye in the display material according to the present invention is not particularly limited, but a content of the dichroic dye is preferably from 0.1% to 15% by mass, more preferably from 0.5% to 10% by mass, and furthermore preferably from 1% to 8% by mass based on a content of the liquid crystal. In addition, regarding a content of the liquid crystal and the dichroic dye, it is desirable that liquid crystal compositions containing both of them are prepared, an absorption spectrum of a liquid crystal cell in which the liquid crystal composition is enclosed is measured, respectively, and a necessary dye concentration for exhibiting a desired optical concentration as the liquid crystal cell is determined.

### (Other Additive)

For the purpose of changing physical property of the cholesteric liquid crystal in a desired range (for example for the purpose of adjusting a temperature range of a liquid crystal phase in a desired range), a compound exhibiting no liquid crystal property may be added. In addition, a compound such as an ultraviolet absorbing agent and an antioxidant may be contained.

With respect to display performance of the display material according to the present invention, a ratio of reflectivity of light in its scattering state or colored state and transparent state (scattering state or colored state/transparent state) is preferably in a range of from 2 to 1000, more preferably in a range of from 5 to 1000, and furthermore preferably in a range of from 8 to 1000.

In the cholesteric liquid crystal layer, layers reflecting or absorbing plural different lights may be juxtaposed, or may be laminated. By adopting such the construction, the number of displayable colors is increased, and aesthetic property may be further enhanced.

### [Electrode]

As the electrode, gold, silver, copper and aluminum are suitably used. In addition, a transparent electrode may be formed of, for example, indium oxide, ITO (Indium Tin Oxide), tin oxide, transparent electrically conductive polymer (e.g. trade name PEDOT/PSS, manufactured by Nagase ChemteX Corporation or Stark), or a carbon nano-tube and, when applied to an automobile member having many curved surfaces, to formed by an electrically conductive polymer or a carbon nano-tube is preferable from a viewpoint of stability to bending or straining.

As the transparent electrode, for example, a transparent electrode described on page 232 to page 239 of “Liquid Crystal Device Handbook” (edited by Japan Society for the Promotion of Science 142^{nd} Committee, The Nikkan Kogyo Shimbun, Ltd., 1989) is used.

### [Spacer]

The display material according to the present invention may be manufactured by opposing one pair of substrates at a gap of from 1 μm to 50 μm via a spacer, and arranging the liquid crystal composition in a space formed between substrates.

As the spacer, for example, a spacer described on page 257 to page 262 of “Liquid Crystal Device Handbook” (edited by Japan Society for the Promotion of Science 142^{nd} Committee, The Nikkan Kogyo Shimbun, 1989) may be used.

The display material according to the present invention may be arranged in a space between substrates by coating or printing the liquid crystal composition on a substrate.

In the case of the display material according to the present invention, a thickness of the cholesteric liquid crystal layer, that is, a gap between substrates formed by a spacer is preferably from 1 μm 100 μm, and more preferably form 2 μm to 40 μm. When the thickness is greater than 100 μm, transmittance in the transparent state is easily reduced and, when the thickness is smaller than 1 μm, display unevenness is easily generated due to a partial defect, being not preferred.

### [Support]

The display material according to the present invention has at least one support. The support is not particularly limited, and a metal, a glass, a plastic, a paper or a ceramics is suitably used.

As the metal iron, stainless or aluminum is preferably used. Examples of the plastic substrate support used in the present invention include triacetylcellulose (TAC), polyethylene terephthalate (PET), polyethylene naphthalate (PEN), syndiotactic polystyrene (SPS), polyphenylene sulfide (PPS), polycarbonate (PC), polyarylate (PAr), polysulfone (PSF), polyestersulfone (PES), polyetherimide (PEI), cyclic polyolefin, and polyimide (PI). Preferable is polyethylene terephthalate (PET).

The resin having a thermal expansion coefficient of 30 ppm/° C. or lower is preferable. The thermal expansion coefficient referred herein was measured with TMA8310 (Thermo Plus Series, manufactured by Rigaku Corporation). Examples include PET (trade name Lumilar, manufactured by TORAY Industries, Inc.; 15 ppm/° C.), PEN (Q65A, manufactured by DuPont-Teijin; 20 ppm/° C.), PI (Upilex, manufactured by UBE INDUSTRIES, LTD; 20 ppm/° C.), and aramide resin (Teijin; 2 ppm/° C.).

Alternatively, a thermal expansion coefficient of 30 ppm or lower may be obtained by adding an inorganic material such as a glass, a cloth, and a glass fiber by a sol-gel method into a resin having a glass transition temperature (Tg) of 150° C. or higher listed below.

Preferable examples (the interior in parenthesis indicates Tg) include a polycarbonate resin (pc: 140° C.), an alicyclic polyolefin resin (e.g. trade name ZEONOR 1600, manufactured by ZEON CORPORATION: 160° C.; trade name ARTON, manufactured by JSR: 170° C.), a polyarylate resin (PAr: 210° C.), a polyether sulfone resin (PES: 220° C.), a polysulfone resin (PSF: 190° C.), a polyester (e.g. trade name O-PET, manufactured by Kanebo: 125° C., polyethylene terephthalate, polyethylene naphthalate), a cycloolefin copolymer (COC: compound of Example 1 of JP-A No. 2001-150584: 162° C.), a fluorene ring-modified polycarbonate resin (BCF-PC: compound of Example-4 of JP-A No. 2000-22760: 225° C.), an alicycle-modified polycarbonate resin (IP-PC: compound of Example-5 of JP-A No. 2000-227603: 205° C.), and an acryloyl compound (compound of Example-1 of JP-A No. 2002-80616: 300° C. or higher).

As a polymer substrate used in the present invention, a crosslinked resin may be also preferably used from a viewpoint of solvent resistance and heat resistance. As a kind of the crosslinked resin, various known thermosetting resins and radiation-setting resins may be used without any limitation. Examples of the thermosetting resin include a phenol resin, a urea resin, a melamine resin, an unsaturated polyester resin, an epoxy resin, a silicone resin, a diallyl phthalate resin, a furan resin, a bismaleimide resin, and a cyanate resin. As the crosslinking method, a reaction for forming a covalent bond may be used without any limitation, and a system in which a reaction proceeds at room temperature, such as a system that a polyalcohol compound and a polyisocyanate compound may be used to form a urethane bond, may be used without any limitation. However, such the system is problematic in a pot life before film making in many cases and, usually, a two-solution mix type which is added a polyisocyanate compound thereof immediately before film making is used. On the other hand, when used as a one-solution type, it is effective to protect a functional group which participates in a crosslinking reaction, and a block type curing agent is also commercially available. As the commercially available block type curing agent, B-882N manufactured by MITSUI CHEMICALS POLYURETHANES, INC., Colonate 2513 manufactured by NIHON POLYURETHANE KOGYO CO., LTD (forgoing is block polyisocyanate) and Cymel 303 manufactured by Mitsui Cytec (methylated melanine resin) are known.

### [Protecting Layer]

The substrate used in the present invention may have a protecting layer. Examples of a polymer used in the protecting layer include a water-soluble polymer, a cellulose acylate, a latex polymer, and a water-soluble polyester. Examples of the water-soluble polymer include gelatin, gelatin derivative, casein, agar, sodium arginate, starch, polyvinyl alcohol, polyacrylic acid copolymer, and maleic anhydride copolymer, and examples of the cellulose acylate include carboxymethylcellulose and hydroxyethylcellulose. Examples of the latex polymer include a vinyl chloride-containing copolymer, a vinylidene chloride-containing copolymer, an acrylic acid ester-containing copolymer, a vinyl acetate-containing copolymer and butadiene-containing copolymer.

The protecting layer may contain an inorganic or organic fine particle as a matting agent within an extent that transparency of a barrier film substrate is not substantially deteriorated. As the matting agent of an inorganic fine particle, silica (SiO₂), titanium dioxide (TiO₂), calcium carbonate, and magnesium carbonate may be used. As the matting agent of an organic fine particle, polymethyl methacrylate, cellulose acetate propionate, polystyrene, an agent soluble in a treating solution described in U.S. Pat. No. 4,142,894, and a polymer described in U.S. Pat. No. 4,396,706 may be used.

An average particle size of these fine particle matting agents is preferably from 0.01 μm to 10 μm, and more preferably from 0.05 μm to 5 μm. And, a content thereof is preferably from 0.5 mg/m² to 600 mg/m², and more preferably from 1 mg/m² to 400 mg/m².

The protecting layer may be coated by the generally well-known coating method, for example, a dip coating method, an air knife coating method, a curtain coating method, a roller coating method, a wire bar coating method, a gravure coating method, a slide coating method, or an extrusion coating method using a hopper described in U.S. Pat. No. 2,681,294.

### [Barrier Layer]

The substrate used in the present invention may have a barrier layer in order to suppress deterioration of a member due to penetration of water or oxygen.

The barrier layer may be formed of any of an organic polymer system, an inorganic system, and a composite system thereof. Examples of the organic polymer system include ethylene-vinyl alcohol (EVOH), polyvinyl alcohol (PVA/PVOH), nylon MXD6 (N-MXD), and nano-composite-based nylon. Examples of the inorganic system include a silica, an alumina and a binary system. Details thereof are described in, for example “Development of High Barrier Material, Film Making Technique, and Method of Measuring/Assessing Barrier Property” (Technical Information Institute Co., LTD, 2004).

When the support is a plastic film, it is preferable to apply a laminate in which an inorganic layer and an organic layer are alternately laminated, to the barrier layer. Penetration of water and oxygen is effectively prevented, and the barrier layer is peeled with difficulty under the condition of high temperature and high humidity due to the organic layer.

The barrier layer of a laminate preferably contains a structure in which an inorganic layer and an organic layer are alternately laminated from a plastic film side, and at least a first inorganic layer, an organic layer (first organic layer), and a second inorganic layer are laminated in this order from a plastic film side. On the second inorganic layer, one or more layers may be laminated, for example, a second organic layer, a third inorganic layer; a third organic layer, a fourth inorganic layer, a fourth organic layer and a fifth inorganic layer and the like. An uppermost layer of the alternate laminate may be an inorganic layer or an organic layer.

When an inorganic layer is provided on a plastic film side, penetration of water and oxygen is prevented effectively, and when prepared into a laminate having alternately an inorganic layer and an organic layer from a plastic film side, the effect is accumulated more, being effective.

The barrier layer is provided on a surface of the support on a side of a surface not holding a color layer. The barrier layer may be provided on one support, or both supports, of one pair of supports, and it is preferable to provide the barrier layer on both supports.

### [Antistatic Layer]

The substrate used in the present invention may have an antistatic layer (electrically conducted layer). It is preferable that the antistatic layer is formed on a back of the substrate (surface on which an inorganic organic alternate laminate is not formed). The antistatic layer is formed, specifically, by providing a layer containing an ion electrically conductive substance or an electrically conductive fine particle.

Herein, the ion electrically conductive substance is a substance exhibiting electric conductivity and containing an ion which is a carrier carrying electricity, and examples include an ionic polymer compound. Examples of the ionic polymer compound include an anionic polymer compound seen in each gazette of JP-B No. 49-23828, JP-B No. 49-23827, and JP-B No. 47-28937; an ionene-type polymer having a dissociating group in a main chain, seen in each gazette of JP-B No. 55-734, JP-A No. 50-54672, JP-B No. 59-14735, JP-B No. 57-18175, JP-B No. 57-18176, and JP-B No. 57-56059; a cationic pendant-type polymer having a cationic dissociating group in a side chain, seen in each gazette of JP-B No. 53-13223, JP-B No. 57-15376, JP-B No. 53-45231, JP-B No. 55-145783, JP-B No. 55-65950, JP-B No. 55-67746, JP-B No. 57-11342, JP-B No. 57-19735, JP-B No. 58-56858, JP-A No. 61-27853, and JP-B No. 62-9346.

As an example of metal oxide as the electrically conductive fine particle, ZnO, TiO₂, SnO₂, Al₂O₃, In₂O₃, SiO₂, MgO, BaO, MoO₂, V₂O₅, and a composite oxide thereof are preferable, and ZnO, TiO₂ and SnO₂ are particularly preferable. As an example of inclusion of a heterogenous atom, for example, addition of Al or In to ZnO, addition of Nb or Ta to TiO₂, and addition of Sb, Nb, or a halogen element to SnO₂ are effective. An addition amount of these heterogenous atoms is preferably in a range of from 0.01 mol % to 25 mol %, particularly preferably in a range of from 0.1 mol % to 15 mol %.

### [Other Functional Layer]

On the substrate according to the present invention, a smoothing layer, an adherability improving layer, a light shielding layer, an antireflective layer, and a hard coating layer may be provided, if necessary.

### [Other Member]

Examples of other member include a barrier film, an ultraviolet absorbing layer, an antireflective layer, a hard coating layer, a stain preventing layer, an interorganic layer insulating film, a metal reflecting plate, a phase difference plate, and an orientation film. These may be used alone or two or more kinds may be used in combination.

It is preferable that an ultraviolet absorbing layer contains an antioxidant such as 2,2-thiobis(4-methyl-6-t-butylphenol), or 2,6-di-t-butylphenol: an ultraviolet absorbing agent such as 2-(3-t-butyl-5-methyl-2-hydroxyphenyl)-5-chlorobenzotriazole, or alkoxybenzophenone.

The antireflective film is formed using an inorganic material or an organic material and a film construction may be a single layer or multiple layers. Further, the construction may be a multi-layer structure of an inorganic material film and an organic material film. The antireflective film may be provided on one side or both sides. When provided on both sides, the antireflective films on both sides may be the same construction or may be different constructions.

Examples of the inorganic material used in the antireflective film include SiO₂, SiO, ZrO₂, TiO₂, TiO, Ti₂O₃, Ti₂O₅, Al₂O₃, Ta₂O₅, CeO₂, MgO, Y₂O₃, SnO₂, MgF₂, or WO₃, and these may be used alone, or two or more kinds may be used in combination. Among them, due to a plastic, SiO₂, ZrO₂, TiO₂, or Ta₂O₅ on which vacuum deposition is possible at a low temperature are preferable.

Examples of the multi-layer film formed by an inorganic material include a lamination structure in which a material layer having a high refractive index and a material layer having a high refractive index are alternately made into a film, having a total optical thickness of a ZrO₂ layer and a SiO₂ layer of λ/4, an optical thickness of a ZrO₂ layer of λ/4, and an optical thickness of a SiO₂ layer as an uppermost layer of λ/4 in this order from a support side. Herein, λ is a designed wavelength, and λ=520 nm is usually used. SiO₂ is preferable, since an uppermost layer has a low refractive index, and a mechanical strength may be imparted to the antireflective film.

When the antireflective film is formed by an inorganic material, as a film making method, for example, a vacuum deposition method, an ion plating method, a sputtering method, a CVD method, and a method of precipitation by a chemical reaction in a saturated solution may be adopted.

Examples of an organic material used in the antireflective film include FFP (tetrafluoroethylene-hexafluolopropylene copolymer), PTFE (polytetrafluoroethylene) or ETFE (ethylene-tetrafluoroethylene copolymer), and the material is selected considering a refractive index of the support material and the hard coating film (if any). As the film forming method, a film may be made by a coating method excellent in mass productivity, such as a spin coating method, and a dip coating method in addition to a vacuum deposition method.

As the hard coating layer, the known ultraviolet curing or electron beam curing acryl-based or epoxy-based resin may be used.

As the stain preventing film, a water-repellent oil-repellent material such as a fluorine-containing organic polymer may be used.

As the orientation film, polyimide, silane coupling agent, polyvinyl alcohol, and gelatin are preferably used, and polyimide, and silane coupling agent are preferably used from a viewpoint of orientation ability, durability, insulating property and the cost. As the orientation method, a material may be or not may be rubbing-treated. The orientation state may be any of the horizontal state and the vertical state.

In the display material according to the present invention, when a temperature sensor is provided, and a temperature is controlled so as to keep a temperature at 0° C. or higher with a sheet-like heater described later, display property may be further stably maintained. Specifically, as a temperature sensor, temperature sensors manufactured by National Semiconductor Corporation, and FUJI ELECTRIC SYSTEMS Co., Ltd. may be applied.

The temperature sensor is preferably mounted at the place so that a temperature of the display material according to the present invention may be correctly measured.

In addition, in order to control the temperature, it is suitable to provide a sheet-like heater to maintain display property to be high at a low temperature, particularly at a freezing point or lower. Specifically, as the sheet-like heater, a sheet-like heater manufactured by Honeywell Japan Inc. may be applied.

The sheet-like heater is preferably mounted on a light incident side of the automobile member according to the present invention, or on a side opposite to an incident side.

In addition, it is suitable that the sheet-like heater is transparent from the viewpoint of display property.

### [Shape of Display Material]

The display material according to the present invention may be planar or curved. In the case of a curved surface, the material may be a single curved surface or a double-curved surface. A degree of the curved surface may be any value as long as a curvature radius is not 0, but the radius is preferably in a range of from 10 mm to 100 m, and more preferably in a range of from 20 mm to 10 m.

### (Utility)

The display material according to the present invention may be driven at a low driving voltage. When the driving voltage may be lowered, this is advantageous in that (1) a consumption power may be reduced not to be burdened for the environment, (2) a driver for driving becomes inexpensive, and (3) it becomes possible to suppress deterioration of the display material to prolong a life of the material.

As described above, in the display material according to the present invention, deterioration of display performance due to vibration or impact is also suppressed. Therefore, display with improved vibration resistance and impact resistance becomes possible, and this may be particularly suitably used for an automobile.

The material may be applied to a glass such as a front glass, a side glass, a rear glass, a sun roof, and a back mirror as the automobile member. When the display material according to the present invention is applied to these glasses, since light of an arbitrary wavelength may be reflected, the anti-glaring effect at driving, improvement in a fuel fee and improvement in comfort due to heat shielding, and improvement in security, and aesthetic property may be realized.

Specifically, by using the display technique under a outdoor sunny place, an illuminance in an automobile chamber may be easily adjusted electrically, and it becomes possible to spend comfortably. When applied for a front glass, it becomes possible to shield glare at an exit of a tunnel, and direct sunlight of the afternoon sun, and safer driving becomes possible. When used in summer, it is possible to prevent a temperature rise, and a load of an air conditioner in a car becomes small, consequently leading to improvement in a fuel cost.

In addition, when the display material of the present invention is applied to an automobile body, the material may be suitably used as interior, advertisement or information display method.

When the display material according to the present invention is used as an automobile member, a display method of switching white scattering and colorless transparency, and a display method of a guest-host system using the dichroic dye may be used and, in view of outdoor durability, it is suitable to adopt a display method exhibiting a structural color.

### EXAMPLES

The characteristics of the present invention will be explained more specifically below by way of Examples. A material, a use amount, a ratio, a treating content, and a treating procedure shown in the following Examples may be conveniently changed without departing from the gist of the present invention. Therefore, the following Examples should not be construed to limit a scope of the present invention.

### Example 1

### Selective Reflecting System Due to Cholesteric Liquid Crystal

### 1. Manufacturing of Plastic Substrate

According to the same manner as that of the manufacturing of sample 110 of Example 1 in JP-A No. 2000-105445, an undercoating layer and a back layer for PEN (Dupont-Teijin Q65A) were manufactured. That is, 100 parts by weight of a polyethylene-2,6-naphthalate polymer and 2 parts by weight of Tinuvin P.326 (manufactured by Ciba Geigy) as an ultraviolet absorber were dried, melted at 300° C., extruded through a T-type die, longitudinally stretched at a 3.3-fold rate at 140° C., subsequently transversely stretched at a 3.3-fold rate at 130° C., and further thermally set at 250° C. for 6 seconds to obtain a plastic substrate (PEN) of the present invention having a thickness of 90 μm.

### 2. Manufacturing of Transparent Electrode Layer

One side of the resulting plastic substrate was coated with electrically conductive indium tin oxide (ITO) by deposition to obtain a uniform thin film having a thickness of 200 nm. A surface resistivity was about 20 Ω/cm², and a light transmittance (500 nm) was 85%.

Then, a SiO₂ thin film (100 nm) was provided on the ITO surface as an antireflective film by sputtering. A light transmittance (500 nm) was 90%.

### 3. Preparation of Cholesteric Layer

A polyimide vertically oriented film (trade name: SE1211, manufactured by NISSAN CHEMICAL INDUSTRIES, LTD.) was coated on a transparent electrode side of the support. Then, the chiral reagent No. 14 according to the present invention at an amount adjusted so as to have a selective reflection peak at 550 nm was added to 1.0 g of a cyano-based nematic liquid crystal (trade name ZLI-1132, manufactured by Merck, Δ∈=+13) to prepare a cholesteric liquid crystal composition. Specifically, the chiral reagent No. 14 was added at 6.0% by mass based on 100% by mass of the nematic liquid crystal (ZLI-1132).

A small amount of 20 μm spherical spacers (manufactured by SEKISUI CHEMICAL CO., LTD.) was mixed into the resulting cholesteric liquid crystal composition. The cholesteric liquid crystal composition was coated on the plastic substrate provided with ITO, being sandwiched with an oriented film side in contact with the liquid crystal layer, and this was sealed with a photocuring sealing agent (manufactured by SEKISUI CHEMICAL CO., LTD.), and then wired.

### 4. Assessment of Display Performance

When, after an alternating current voltage of ±100 V (100 Hz) was applied to the resulting display film of Example 1 using a signal generator (manufactured by Tektronix, Inc.), an application voltage was made to be zero instantaneously, the cholesteric liquid crystal of Example 1 was brought into a planar state and exhibited a selective reflection peak at 550 nm. This state was stably present at room temperature for one month or longer, and it was confirmed that there is excellent display maintenance property.

When an alternating current voltage of ±40 V (100 Hz) was applied and an application voltage was gradually made to be zero, the cholesteric liquid crystal of Example 1 was brought into a focal conic state and became transparent. This state was stably present at room temperature for one month or longer, and it was confirmed that there is excellent display maintenance property (memory property).

### Comparative Example 1

According to the same manner as that of Example 1 except that the following compound C-1 was used as a chiral reagent with no fluorine introduced, a display film of Comparative Example 1 exhibiting a selective reflection peak at 550 nm was manufactured.

An alternating current voltage of ±40 V (100 Hz) was applied to the display film of Comparative Example, however, orientation of the cholesteric liquid crystal was not changed. When an alternating current voltage of ±75 V (100 Hz) was applied, and an application voltage was gradually made to be zero, orientation of the cholesteric liquid crystal was changed, and the crystal became transparent. This state was stably present at room temperature for one month or longer.

That is, it was seen that the display film of Example 1 to which the chiral reagent having at least one fluorine atom was applied has a lower driving voltage than that of the display film of Comparative Example 1.

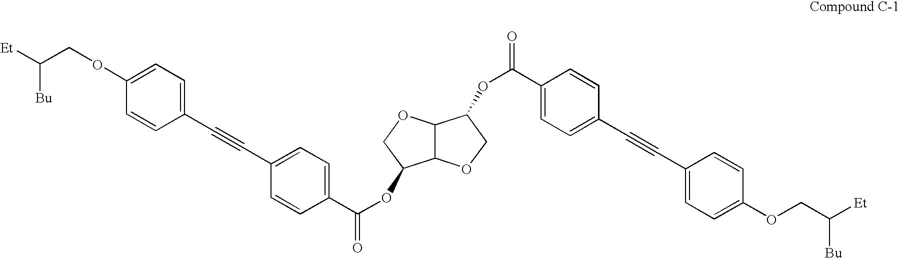

### Example 2

### Application to Selective Reflection Mode for in-Car Due to Cholesteric Liquid Crystal

The display film obtained in Example 1 was applied to a front glass, a rear glass, and a sun roof of an automobile from an inner side using an epoxy-based adhesive. These glasses were all not planar, but multiple-curved surface.

After an adhesive was provided on both sides of the resulting display film, this was sandwiched with two tempered glasses to prepare a laminated glass of Example 2.

### (Assessment of Display Performance)

When assessment was performed as in Example 1, it was confirmed that the laminated glass of Example 2 is driven at the same driving voltage as that of Example 1.

### (Assessment of Vibration Resistance)

A vibration test according to MIL-STD-883E for the laminated glass obtained in Example 2 was performed under the following conditions. Defining a step of adding vibration from 20 Hz to 1000 Hz and returning to 20 Hz as one cycle (about 4 minutes), four cycles were conducted.

After this test, the display performance was assessed, and deterioration of display performance (display variation, reduction in a display contrast ratio etc.) was not particularly shown. That is, it was confirmed that the laminated glass of Example 2 has improved stability with respect to vibration.

### (Assessment of Impact Resistance)

Impact resistance was assessed by a test method shown in JIS D5500 5.5. As a result, deterioration of display performance (display variation, reduction in a display contrast ratio etc.) was not particularly shown. That is, it was confirmed that the laminated glass of Example 2 has improved stability with respect to impact.

### (Assessment of Light Durability)

The film of the present invention was irradiated with a Xe lamp (150000 lux) (480 hours), and no change was shown in electric properties. That is, it was confirmed that the laminated glass of Example 2 is excellent in light durability.

From the result of Example 2, when the cholesteric liquid crystal composition containing a chiral reagent having at least one fluorine atom is applied, display with improved vibration resistance and impact resistance becomes possible, and it was made clear that the material is particularly suitable as an automobile member.

In addition, it was made clear that the laminated glass of Example 2 is excellent in light durability. Therefore, it was made clear that the laminated glass of Example 2 is excellent in durability when used outdoor, and is suitable as an automobile member.

### Comparative Example 2

According to the same manner as that of Example 2, a laminated glass of Comparative Example 2 was manufactured, except that in Comparative Example 2, the display film obtained in Comparative Example 1 (display film containing a chiral reagent C-1 with no fluorine introduced) was used. Regarding the laminated glass of Example 2, vibration resistance and impact resistance were assessed as in Comparative Example 2.

As a result, it was confirmed that display variation occurs by vibration and impact in the laminated glass of Comparative Example 2 using the chiral reagent with no fluorine introduced.

### Example 3

### Cholesteric Liquid Crystal Phase Exhibiting Selective Reflection in Near Infrared Region

According to the same manner as that of Example 1 except that an addition amount of the chiral reagent was adjusted so that a peak of selective reflection became 900 nm, a film of Example 3 was manufactured. Specifically, the chiral reagent No. 14 was added at 3.7% by mass based on 100% by mass of the nematic liquid crystal (ZLI-1132).

The resulting film of Example 3 was assessed as in Example 1. When, after an alternating current voltage of ±35 V (100 Hz) was applied to the film of Example 3, an application voltage was made to be zero instantaneously, the cholesteric liquid crystal was brought into a planar state and exhibited a selective reflection peak at 900 nm. This state was stably present at room temperature for one month or longer, and it was confirmed that there is excellent display maintenance property.

In addition, when an alternating current voltage of ±30 V (100 Hz) was applied and an application voltage was gradually made to be zero, the cholesteric liquid crystal of Example 3 was brought into a focal conic state, and became transparent. This state was stably present at room temperature for one month or longer, and it was confirmed that there is excellent display maintenance property (memory property).

### Example 4

### Curved Display Element

On one side of a glass substrate which is not planar but curved surface, electrically conductive indium tin oxide (ITO) was coated by deposition to laminate a uniform thin film having a thickness of 200 nm. A surface resistance was about 10 Ω/cm², and a light transmittance (500 nm) was 88%. According to the same manner as that of Example 0 except for that, a display element of Example 4 was manufactured.

### (Assessment of Display Performance)

The resulting display element of Example 4 was assessed by the same method as that of Example 1. When after an alternating current voltage of 140 V (100 Hz) was applied to the display element of Example 4, an application voltage was made to be zero instantaneously, the cholesteric liquid crystal was brought into a planar state, and exhibited a selective reflection peak at 550 nm. This state was stably present at room temperature for one month or longer, and it was confirmed that there is excellent display maintenance property.

In addition, when an alternating current voltage of ±30 V (100 Hz) was applied, and an application voltage was gradually made to be zero, the cholesteric liquid crystal of Example 4 was brought into a focal conic state, and became transparent. This state was stably present at room temperature for one month or longer, it was confirmed that there is excellent display maintenance property (memory property).

### Example 5

Using polycarbonate (manufactured by Teijin) as a curved plastic substrate, a PEDOT/PSS dispersion in water (manufactured by NAGASE CHEMICAL CO., LTD) as an electrically conductive polymer was coated and dried. A thickness of the resulting plastic substrate was 8 μm, a surface resistance was about 500 Ω/cm², and a light transmittance at 500 nm was 88%.

According to the same manner as that of Example 1 except that ZLI-4792 was used as a host liquid crystal, a display element of Example 5 having a cholesteric liquid crystal layer exhibiting selective reflection on a transparent electrode side on the substrate was manufactured.

### (Assessment of Display Performance)

The resulting display element of Example 5 was assessed by the same method as that of Example 1. When, after an alternating current voltage of ±40 V (100 Hz) was applied to the display element of Example 5, an application voltage was made to be zero instantaneously, the cholesteric liquid crystal was brought into a planar state, and exhibited a selective reflection peak at 550 nm. This state was stably present at room temperature for one month or longer, and it was confirmed that there is excellent display maintenance property.

In addition, when an alternating current voltage of ±35 V (100 Hz) was applied, and an application voltage was gradually made to be zero, the cholesteric liquid crystal of Example 5 was brought into a focal conic state, and became transparent. This state was stably present at room temperature for one month or longer, and it was confirmed that there is better display maintenance property (memory property).

### (Assessment of Durability)

The display element of Example 5 was irradiated with a Xe lamp (150,000 lux) (480 hours), and no change was shown in electric property. That is, it was confirmed that the display element of Example 5 is excellent also in light resistance.

In addition, after the display element of Example 5 was allowed to stand for 3 weeks under the environment of 85° C. and a humidity of 95%, electric property was assessed, and no change was shown in electric property. That is, it was confirmed that the display element of Example 5 is excellent in stability under high temperature and high humidity.

Further, after the display element of Example 5 was allowed to stand for 1 week under the environment at −20° C., electric property was assessed, and no change was shown in electric property. That is, it was confirmed that the automobile member of Example 5 is excellent in stability under a low temperature.

Regarding the display element of Example 5, vibration resistance and impact resistance were performed as in Example 2, and it was confirmed that the element is excellent in vibration resistance and impact resistance.

### Example 6

According to the same manner as that of Example 5 except that a ultraviolet absorbing layer (trade name UV guard, manufactured by FUJIFILM Business Supply Co., Ltd.) was provided on a light incident side of a support in Example 6, a curved automobile member of Example 6 was manufactured.

### (Assessment of Display Performance)

The resulting display element of Example 6 was assessed by the same method as that of Example 1, and it was confirmed that the element is driven at the same driving voltage as that of Example 1.

### (Assessment of Light Durability)

It was confirmed that, in the display element of Example 6, deterioration of display performance due to ultraviolet irradiation is small.

### Example 7

According to the same manner as that of Example 2 except that the laminated glass was not prepared, but a glass was provided only on one side and, further, a barrier layer was provided on a light incident side of a support in Example 7, a curved automobile member of Example 7 having a cholesteric liquid crystal layer exhibiting selective reflection was manufactured.

As the barrier layer, an inorganic layer (aluminum oxide) was formed as a first inorganic layer using a sputtering device. Then, as a first organic layer, a mixed solution of 20 g of the following monomer (M-1), 0.6 g of a ultraviolet polymerization initiator (trade name Irgacure Irg184, manufactured by Ciba) and 200 g of 2-butanone was coated using a wire bar so that a liquid thickness became 5 μm. This was cured by irradiating a ultraviolet ray from a high pressure mercury lamp (accumulated irradiation amount about 2 J/cm²) at room temperature, to form a first organic layer. A film thickness was about 500 nm in any case.

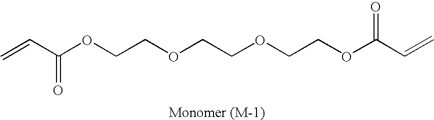

By forming a second inorganic layer, a second organic layer, a third inorganic layer, and a third organic layer according to the similar manner, a barrier layer was manufactured.

### (Assessment of Display Performance)

The resulting display element of Example 7 was assessed as in Example 1, and it was confirmed that the element is driven at the same driving voltage as that of Example 1.

### (Assessment of Durability)

It was confirmed that, in the automobile member of the present invention, deterioration of display performance under high humidity is small.

### Example 8

According to the same manner as that of Example 4 except that a sheet-like transparent heater (manufactured by Haneywell Japan Inc.) and a temperature sensor (manufactured by National Semiconductor Corporation) were disposed on one side, and set so that, when a temperature becomes 0° C. or lower, the heater is automatically worked, and the automobile member is retained at 0° C. or higher, a sheet-like automobile member of Example 8 having a cholesteric liquid crystal layer exhibiting selective reflection was manufactured.

The resulting display element of Example 8 was assessed by the same method as that of Example 1, and it was confirmed that the element is driven at the same driving voltage as that of Example 4.

It was confirmed that the display element of Example 8 exhibits excellent display performance even under the environment of a freezing point or lower.

### Example 9

### Development into Guest-Host Liquid Crystal System

### (Preparation of Display Material)

A polyimide horizontal oriented film (manufactured by NISSAN CHEMICAL INDUSTRIES, LTD.) was provided on a glass substrate with ITO which is a transparent electrode, by spin coating, and firing. Then, the resulting horizontal oriented film on the glass substrate was subjected to rubbing treatment.

A dichroic dye shown in the following Table 1 and a chiral reagent No. 14 were dissolved in 1.0 g of a host liquid crystal (nematic liquid crystal: ZLI-1132 Δ∈=+13) by heating, and this was allowed to stand under room temperature for one day.

An addition amount of each dichroic dye was adjusted so that a transmittance became 20% when the liquid crystal composition was injected into a 8 μm cell for assessing a liquid crystal. An addition amount of the chiral reagent was adjusted so that a spiral angle became 360° when injected into a 8 μm cell. Specifically, the chiral reagent No. 14 was added at 0.42% by mass based on 100% by mass of the nematic liquid crystal (ZLI-1132).

A small amount of 8 μm spherical spacers (manufactured by SEKISUI CHEMICAL CO., LTD.) was mixed into the resulting liquid crystal composition. The liquid crystal composition was sandwiched with the plastic substrate provided with ITO so that the oriented film contact with the liquid crystal layer, and this was sealed with a photocuring sealing agent (manufactured by SEKISUI CHEMICAL CO., LTD.).

TABLE 1

| Dichroic dye No. | Comment |
|---|---|
| 1-1 | Yellow dye |
| 1-8 | Magenta dye |
| 1-10 | Cyan dye |

The resulting display material of the present invention was in a colored state at the time of application of no voltage. In any display element, when a voltage (±20 V, 100 Hz) was applied using a signal generator (manufactured by Tektronix, Inc.), the liquid crystal layer was brought into a transparent state.

### Comparative Example 3

According to the same manner as that of Example 9 except that the chiral reagent was changed to the compound C-1, a display element of Comparative Example 3 was manufactured. As a dye, a yellow dye of 1-1 was used.

In the resulting display element of Comparative Example 3, a liquid crystal was not changed at an alternating current voltage of +20 V, 100 Hz, and an alternating current voltage of ±50 V, 100 Hz was necessary for making the liquid crystal layer transparent. That is, it was confirmed that the display element of a guest-host liquid crystal system of Example 9 has a lower driving voltage than that of the display element of Comparative Example 3.

### Example 10

### Development into Guest-Host Liquid Crystal System

### 1. Manufacturing of Plastic Substrate

According to the same manner as that of the manufacturing of sample 110 of Example 1 in JP-A No. 2000-105445, an undercoating layer and a back layer for PEN (Dupont-Teijin Q65A) were manufactured. That is, 100 parts by weight of a polyethylene-2,6-naphthalate polymer and 2 parts by weight of Tinuvin P.326 (manufactured by Ciba Geigy) as an ultraviolet absorber were dried, melted at 300° C., extruded through a T-type die, longitudinally stretched at a 3.3-fold rate at 140° C., subsequently transversely stretched at a 3.3-fold rate at 130° C., and further thermally set at 250° C. for 6 seconds to obtain a plastic substrate (PEN) of the present invention having a thickness of 90 μm.

### 2. Manufacturing of Transparent Electrode Layer

On one side of the above-obtained plastic substrate, electrically conductive indium tin oxide (ITO) was coated by deposition to laminate a uniform thin film having a thickness of 200 nm. A surface resistance was about 20 Ω/cm², and a light transmittance (500 nm) was 85%. Then, a SiO₂ thin film (100 nm) as a antireflective film was provided on an ITO surface. A light transmittance (500 nm) was 90%.

### 3. Preparation of Cholesteric Layer

A polyimide vertical oriented film (trade name SE1211, manufactured by NISSAN CHEMICAL INDUSTRIES, LTD.) was coated on a transparent electrode side of the support. Then, a small amount of a 10 μm spherical spacer (manufactured by SEKISUI CHEMICAL CO., LTD.) was mixed into a liquid crystal composition in which the chiral reagent No. 14 and the dichroic dye No. 1-8 had been dissolved in 1.0 g of a fluorine-based nematic liquid crystal (ZLI-6609, manufactured by Merck, Δ∈=−3.7).

An addition amount of each of the chroic dyes was adjusted so that a transmittance became 20% when the liquid crystal composition was injected into a 8 μm cell for assessing the liquid crystal. An addition amount of the chiral reagent was adjusted so that a spiral angle became 360° when injected into a 8 μm cell. Specifically, the chiral reagent No. 14 was added at 0.42% by mass based on 100% by mass of the nematic liquid crystal (ZLI-6609).

The liquid crystal composition was coated on the plastic substrate provided with ITO, being sandwiched with an oriented film side in contact with the liquid crystal layer, and this was sealed with a photocuring sealing agent (manufactured by SEKISUI CHEMICAL CO., LTD.), and then wired.

### 4. Assessment

The resulting display material according to the present invention was in the transparent state at the time of application of no voltage. When a voltage (+8 V, 100 Hz) was applied to this display material using a signal generator (manufactured by Tektronix, Inc.), the liquid crystal layer was brought into the colored state.

### Comparative Example 4

According to the same manner as that of Example 10 except that the chiral reagent was changed to the compound C-1, a display element of Comparative Example 4 was manufactured. As the dichroic dye, a magenta dye of No. 1-8 was used. In the resulting display element, the liquid crystal was not changed at an alternating current voltage of +8 V, 100 Hz, and an alternating current voltage of +12 V, 100 Hz was necessary for making the liquid crystal layer transparent. That is, it was confirmed that the display element of a guest-host liquid crystal system of Example 10 had a lower driving voltage as compared with the display element of Comparative Example 4.

### Examples 11 to 12

According to the same manner as that of Example 1 except that the chiral reagent No. 14 in Example 1 was changed to a chiral reagent shown in the following Table 2, a display element was manufactured. Display property of this display element was assessed as in Example 1. The following Table 2 shows an alternating current voltage at which the element is brought into the focal conic state, as a driving voltage.

### Comparative Examples 5 to 6

By adding each of chiral reagents C-2 and C-3 having the same skeleton as one of the chiral reagents used in Examples 11 to 12 but having no fluorine atom, display elements of Comparative Examples 5 to 6 were manufactured. Display property of display elements were assessed as in Example 1. The following Table 2 shows an alternating current voltage at which the element is brought into the focal conin state, as a driving voltage.

TABLE 2

| | | Addition | | |
|---|---|---|---|---|
| | Chiral | amount of chiral | Selective | Driving |
| | reagent | reagent in liquid crystal | reflection | voltage |
| | No. | composition (mass %) | peak (nm) | (100 Hz) |
| Example 11 | No. 13 | 6.2 | 550 | ±40 V |
| Example 12 | No. 1 | 20 | 650 | ±50 V |
| Comparative | C-2 | 6 | 550 | ±80 V |
| Example 5 | | | | |
| Comparative | C-3 | 20 | 650 | ±95 V |
| Example 6 | | | | |

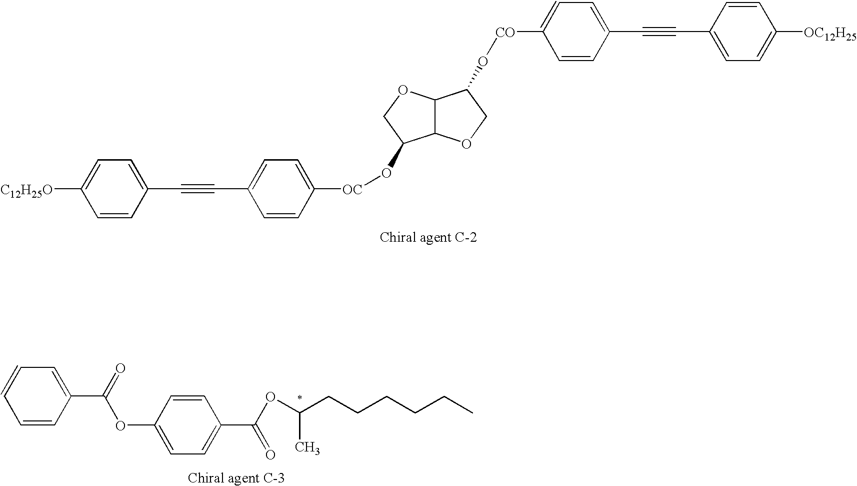

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A display material comprising at least one cholesteric liquid crystal layer whose optical property is changed by an electric field, wherein the cholesteric liquid crystal layer comprises at least one chiral reagent having one or more fluorine atoms, and at least one nematic liquid crystal.

2. The display material according to claim 1, wherein an absolute value of dielectric constant anisotropy of the nematic liquid crystal is 1.0 or larger.

3. The display material according to claim 1, wherein the cholesteric liquid crystal layer reflects light in a visible region, an infrared region or an ultraviolet region.

4. The display material according to claim 1, wherein the cholesteric liquid crystal layer contains a dichroic dye.

5. The display material according to clam 4, wherein the dichroic dye has a substituent represented by the following Formula (1):
-(Het)ⱼ-{(B¹)ₚ-(Q¹)_{q}-(B²)ᵣ}ₙ—C¹ Formula (1)
wherein Het is an oxygen atom or a sulfur atom; B¹ and B² each independently represent an arylene group, a heteroarylene group or a divalent cyclic aliphatic hydrocarbon group; Q¹ represents a divalent linking group; C¹ represents an alkyl group, a cycloalkyl group, an alkoxy group, an alkoxycarbonyl group, an acyl group or an acyloxy group; j represents 0 or 1; p, q and r each independently represent an integer of from 0 to 5; n represents an integer of from 1 to 3; (p+r)×n is an integer of from 3 to 10; when p is 2 or larger, two or more groups represented by B¹ may be the same or different; when q is 2 or larger, two or more groups represented by Q¹ may be the same or different; when r is 2 or larger, two or more groups represented by B² may be the same or different; and when n is 2 or larger, two or more groups represented by {(B¹)ₚ-(Q¹)_{q}-(B²)ᵣ} may be the same or different.

6. The display material according to claim 1, wherein the chiral reagent is at least one chiral reagent represented by following Formula (2): 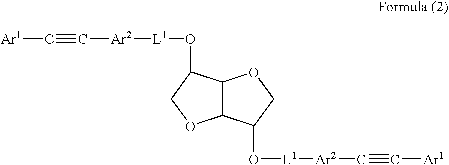
wherein Ar¹ and Ar² each independently represent an aromatic hydrocarbon group or an aromatic heterocyclic group, provided that at least one of Ar¹ and Ar² is an aromatic hydrocarbon group having a fluorine atom or an aromatic heterocyclic group having a fluorine atom; L¹ represents a single bond or a divalent linking group; two groups represented by Ar¹ may be the same or different; two groups represented by Ar² may be the same or different; two groups represented by L¹ may be the same or different; and the aromatic hydrocarbon group, the aromatic heterocyclic group and the divalent linking group may each independently have a substituent.

7. The display material according to claim 6, wherein -L¹-Ar²—C≡C—Ar¹ in Formula (2) is the following Structural Formula (1): 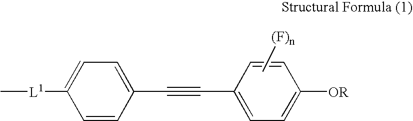
wherein —OR represents an alkoxy group having from 1 to 30 carbon atoms; L¹ represents —C(═O)— or —CH₂—; and n represents from 1 to 4.

8. The display material according to claim 6, wherein -L¹-Ar²—C≡C—Ar¹ in Formula (2) is the following Structural Formula (2): 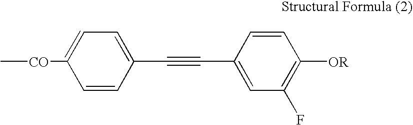
wherein —OR represents an alkoxy group having from 1 to 30 carbon atoms.

9. The display material according to claim 1, wherein the cholesteric liquid crystal layer is sheet-like and positioned between a pair of electrodes, at least one of which is a transparent electrode.

10. The display material according to claim 1, wherein an ultraviolet absorbing layer is disposed on a light incident side with respect to the cholesteric liquid crystal layer.

11. The display material according to claim 1, wherein a barrier layer is disposed on a light incident side with respect to the cholesteric liquid crystal layer.

12. The display material according to claim 9, wherein the electrodes are formed of an electrically conductive polymer or a carbon nano-tube.

13. An automobile member comprising at least one cholesteric liquid crystal layer whose optical property is changed by an electric field, wherein the cholesteric liquid crystal layer comprises at least one chiral reagent having one or more fluorine atoms, and at least one nematic liquid crystal.

14. The automobile member according to claim 13, wherein an absolute value of dielectric constant anisotropy of the nematic liquid crystal is 1.0 or larger.
